(19) United States
(12) Patent Application Publication
(10) Pub. No.: US 2026/0315931 A1
(43) Pub. Date: Oct. 15, 2026

(54) CHARACTER FORMATION METHOD AND APPARATUS IN VIRTUAL SCENE, DEVICE, AND STORAGE MEDIUM

(71) Applicant: TENCENT TECHNOLOGY (SHENZHEN) COMPANY LIMITED, Shenzhen (CN)

(72) Inventors: Mingdong YANG, Shenzhen (CN); Ye KUANG, Shenzhen (CN)

(73) Assignee: TENCENT TECHNOLOGY (SHENZHEN) COMPANY LIMITED, Shenzhen (CN)

(21) Appl. No.: 19/691,022

(22) Filed: May 28, 2026

Related U.S. Application Data
(63) Continuation of application No. PCT/CN2025/072205, filed on Jan. 14, 2025.

(30) Foreign Application Priority Data
Feb. 8, 2024 (CN) 202410179171.9

(51) Int. Cl. A63F 13/58; A63F 13/822

(52) U.S. Cl. CPC A63F 13/58; A63F 13/822

(57) ABSTRACT

A method of character formation in a virtual scene including displaying a character formation interface including the virtual scene, at least one recommended team placement, and at least one preset placement, the at least one recommended team placement being a placement of a recommended team comprising at least one recommended virtual character, the at least one preset placement being a placement that is predetermined, and each of the at least one recommended team placement and the at least one preset placement occupies at least one of a plurality of positions of the virtual scene; and when an operation of selecting a first placement is selected, displaying, in the virtual scene, one or more virtual characters at one or more positions of the plurality of positions based on the first placement, the first placement being one of the at least one recommended team placement or one of the at least one preset placement.

### CROSS-REFERENCE TO RELATED APPLICATIONS

The present disclosure is a bypass continuation application of International Patent Application No. PCT/CN 2025/072205, filed on Jan. 14, 2025, which claims priority to and is based on Chinese Patent Application No. 202410179171.9, filed on Feb. 8, 2024, the disclosures of which are incorporated herein in their entireties by reference.

### FIELD

The present disclosure relates to the field of computer technologies, and in particular, to a character formation method and apparatus in a virtual scene, a device, and a storage medium.

### BACKGROUND

Auto chess is a general term of a card game of an electronic strategy type. A basic game rule thereof is that a player selects a combination between different types of pieces, and then arranges the combination on a board of the player. A system automatically battles against pieces of another player. A particular blood volume is deducted from a defeated side in each turn, and this process is repeated for many times until only one player in a plurality of players lives.

In the related art, an auto chess game has a one-tap formation function for pieces. After a game player selects a desired team of virtual characters, the system calculates combat power of the selected virtual characters through a proper formula, and matches the virtual characters with squares one by one based on a descending priority of the combat power and a priority of the square in the board, to obtain a board after one-tap formation.

However, the one-tap formation function in the foregoing method is only specific to a preset placement in a game, and cannot be applied to a recommended team placement defined by the player.

### SUMMARY

Some embodiments of the present disclosure provide a character formation method and apparatus in a virtual scene, a device, and a storage medium. The technical solutions provided in the embodiments of this application are as follows.

Some embodiments of the present disclosure provide a method of character formation in a virtual scene. The method may include displaying a character formation interface including the virtual scene, at least one recommended team placement, and at least one preset placement, the at least one recommended team placement being a placement of a recommended team comprising at least one recommended virtual character, the at least one preset placement being a placement that is predetermined, and each of the at least one recommended team placement and the at least one preset placement occupies at least one of a plurality of positions of the virtual scene; and when an operation of selecting a first placement is selected, displaying, in the virtual scene, one or more virtual characters at one or more positions of the plurality of positions based on the first placement, the first placement being one of the at least one recommended team placement or one of the at least one preset placement.

Some embodiments of the present disclosure provide a character formation apparatus for a virtual scene. The character formation apparatus may include at least one memory configured to store program code; and at least one processor configured to read the program code and operate as instructed by the program code. The program code may include: display code configured to cause the at least one processor to display a character formation interface comprising the virtual scene, at least one recommended team placement, and at least one preset placement, the at least one recommended team placement being a placement of a recommended team comprising at least one recommended virtual character, the at least one preset placement being a placement that is predetermined, and each of the at least one recommended team placement and the at least one preset placement occupies at least one of a plurality of positions of the virtual scene; and formation code configured to, when an operation of selecting a first placement is selected, display, in the virtual scene, one or more virtual characters at one or more positions of the plurality of positions based on the first placement, the first placement being one of the at least one recommended team placement or one of the at least one preset placement.

Some embodiments of the present disclosure provide a non-transitory computer readable medium storing instructions that, when executed by one or more processors, may cause the one or more processors to: display a character formation interface including a virtual scene, at least one recommended team placement, and at least one preset placement, the at least one recommended team placement being a placement of a recommended team comprising at least one recommended virtual character, the at least one preset placement being a placement that is predetermined, and each of the at least one recommended team placement and the at least one preset placement occupies at least one of a plurality of positions of the virtual scene; and when an operation of selecting a first placement is selected, display, in the virtual scene, one or more virtual characters at one or more positions of the plurality of positions based on the first placement, the first placement being one of the at least one recommended team placement or one of the at least one preset placement.

### BRIEF DESCRIPTION OF THE DRAWINGS

The above and other aspects, features, and advantages of one or more embodiments of the present disclosure will be more apparent from the following description taken in conjunction with the accompanying drawings, in which:

FIG. 1 is a structural block diagram of a computer system according to some embodiments of the present disclosure:

FIG. 2 is a flowchart of a battle interaction method for a turn-based board game according to some embodiments of the present disclosure;

FIG. 3 is a schematic diagram of a battle interface of a turn-based board game according to some embodiments of the disclosure;

FIG. 4 is a schematic diagram of a piece card according to some embodiments of the disclosure;

FIG. 5 is a schematic diagram of an effect card according to some embodiments of the disclosure;

FIG. 6 is a schematic diagram of an item card according to some embodiments of the present disclosure;

FIG. 7 is a schematic diagram of a chess player card according to some embodiments of the present disclosure;

FIG. 8 is a flowchart of a battle interaction method for a turn-based board game according to some embodiments of the present disclosure;

FIG. 9 is a schematic diagram of a chess player selection interface according to some embodiments of the present disclosure;

FIG. 10 is a schematic diagram of a battle interface in a preparation stage according to some embodiments of the present disclosure;

FIG. 11 is a schematic diagram of an interface when a card is played at a preparation stage according to some embodiments of the present disclosure;

FIG. 12 is a schematic diagram of an upgrade process of an upgrade button according to some embodiments of the present disclosure;

FIG. 13 is a schematic diagram of an upgrade process of an upgrade button according to some embodiments of the present disclosure;

FIG. 14 is a schematic diagram of a battle interface in a battle stage according to some embodiments of the present disclosure;

FIG. 15 is a schematic diagram of a settlement interface according to some embodiments of the present disclosure;

FIG. 16 is a flowchart of a character formation method in a virtual scene according to some embodiments of the present disclosure;

FIG. 17 is a schematic diagram of a character formation interface before formation according to some embodiments of the present disclosure;

FIG. 18 is a schematic diagram of a character formation interface after formation based on a recommended team placement according to some embodiments of the present disclosure;

FIG. 19 is a schematic diagram of a mirroring operation of a first placement according to some embodiments of the present disclosure;

FIG. 20 is a schematic diagram of a character formation interface after formation based on a preset placement according to some embodiments of the present disclosure;

FIG. 21 is a schematic diagram of scores of front-row and rear-row virtual characters and virtual items according to some embodiments of the present disclosure;

FIG. 22 is a schematic diagram of a position priority table according to some embodiments of the present disclosure;

FIG. 23 is a flowchart of a formation algorithm corresponding to a preset placement according to some embodiments of the present disclosure;

FIG. 24 is a flowchart of a formation algorithm corresponding to a recommended team placement according to some embodiments of the present disclosure;

FIG. 25 is a block diagram of a character formation apparatus in a virtual scene according to some embodiments of the present disclosure; and

FIG. 26 is a structural block diagram of a computer device according to some embodiments of the present disclosure.

### DESCRIPTION OF EMBODIMENTS

The term, involved in the following description, “some embodiments” describes subsets of all possible embodiments, but “some embodiments” may be the same subset or different subsets of all the possible embodiments and may be combined with each other without conflict.

The operations, techniques, and processes described herein may be implemented via executable instructions or computer program code stored on computer-readable medium. Such computer program code may include distinct portions or modules, where each portion comprises a subset of the total instructions necessary to perform specific operations.

The terms “a,” “an,” “the,” and similar referents in the context of describing the disclosed embodiments (especially in the claims) are to be construed to cover both singular and plural forms, unless otherwise indicated or clearly contradicted by context. The number of items in a plurality is at least two, but may be more when indicated explicitly or by context.

Terms such as “set” (e.g., “a set of items”) or “subset” unless otherwise noted or contradicted by context, is to be construed as a nonempty collection including one or more members. Further, unless otherwise noted or contradicted by context, term “subset” of a corresponding set does not necessarily denote a proper subset of corresponding set, but subset and corresponding set may be equal.

An expression, “a and/or b” may be understood as including only a, only b and both a and b. Expressions “at least one of a, b, and c” and “at least one of a, b, or c” may be understood as including only a, only b, only c, both a and b, both a and c, both b and c, or all of a, b, and c.

Further, unless stated otherwise or otherwise clear from context, phrase “based on” may refer to “based at least in part on” and not “based solely on.”

The terms “first,” “second,” “third,” and the like in the description and in the claims, if any, are used for distinguishing between similar elements and not necessarily for describing a sequential or chronological order. It is to be understood that the terms so used are interchangeable under appropriate circumstances.

With regard to the description of the drawings, similar reference numerals may be used to refer to similar or related components.

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features, numbers, steps, operations, elements, components, or combinations thereof.

To make objectives, technical solutions, and advantages of this application clearer, implementations of this application are further described in detail below with reference to the accompanying drawings. The technical solutions provided in this application may be applied to a turn-based board game. First, terms involved in the embodiments of this application are described.

Turn-based board game: It refers to a board game in which “pieces” are pre-formed before a chess battle, and during the battle, the “pieces” can automatically play against each other according to the pre-formation. The “pieces” are usually represented by virtual characters, and for example, may be referred to as virtual heroes. During the battle, the virtual characters automatically release various skills to battle. Battles are usually turn-based. When all “pieces” of one side in the battle are killed (i.e., a hit point of the virtual character is reduced to zero), this side is a defeated side of the battle of the current turn. In some embodiments, in addition to having “piece virtual characters” for playing a game, two sides of a battle also have chess player characters representing users participating in the battle. The chess player character cannot be moved to a battle area or a candidate piece area as a “piece”. The chess player character is also provided with a hit point (or a blood volume). The hit point of the chess player character is reduced (the battle fails) or stays unchanged (the battle succeeds) based on a result of each battle. When the hit point of the virtual character is reduced to zero, the user corresponding to the chess player character exits the battle, and the remaining user continues to battle. In some embodiments, the turn-based board game includes an auto chess.

Auto chess: It refers to a multi-player turn-based competitive game of an intra-episode hero piece. For example, there are a total of eight or six players in a game, and each of the players occupies an area on a board. Two of a plurality of players perform a one-to-one battle. Each turn of the battle includes two stages: a preparation stage and a battle stage. In the preparation stage, a user purchases pieces (heroes) in a store and makes a deployment on a board. In the battle stage, lineups of both sides are locked, and the pieces automatically combat in the battle until all pieces of one side are killed. A player whose pieces are all killed is the defeated side of the current turn, and a specific amount of the blood volume is deducted from the player. Game turns are continuously repeated and new opponents are matched until the hit point of a player is ≤0 and the player is eliminated. A last remaining player finally wins the game (the first place).

Board: It refers to an area configured to prepare and perform a battle in a battle interface of a turn-based board game. The board may be any one of a two-dimensional (2D) virtual board, a 2.5-dimensional (2.5D) virtual board, and a three-dimensional (3D) virtual board, which is not limited in the present disclosure.

A conventional auto chess board is divided into a battle area and a candidate piece area. The battle area includes several squares having the same size, and the squares are configured for placing pieces engaged in battle during a battle process. The candidate piece area includes several candidate piece positions, the candidate piece positions are configured for placing candidate pieces, and the candidate pieces do not participate in the battle process, but may be dragged and placed in the battle area in a preparation stage. The board area provided in the embodiments of the present disclosure does not include the candidate piece area, but only includes the battle area. Regarding an arrangement manner of squares in the battle area, in some embodiments, the battle area includes n (rows)×m (columns) squares. Exemplarily, n is an integer multiple of 2, and two adjacent rows of squares are aligned, or two adjacent rows of squares are staggered. In addition, the battle area is evenly divided into two parts based on the rows, which respectively are an ally battle area and an enemy battle area. Users participating in the battle are respectively located on an upper side and a lower side of a battle interface. In the preparation stage, the users may only place pieces in the ally battle area. In some other embodiments, the battle area is evenly divided into two parts based on the columns, which respectively are an ally battle area and an enemy battle area. Users participating in the battle are respectively located on a left side and a right side or an upper side and a lower side of a battle interface. A shape of the square may be any one of a square, a rectangle, a circle, and a hexagon. The shape of the square is not limited in the embodiments of the present disclosure.

Card: It is a common term for a game type, and derives from a desktop game. Different from a model in which pieces are placed and directly manipulated, a card carries content in a game on the card. Compared with the pieces, the card is more convenient for carrying some textual descriptions and card attribute information, and conveying some key numerical values. However, “cardization” means making a hero resource into a card resource, so as to facilitate reading and division of a card effect by a player, and carries information in more dimensions.

Energy: It refers to a resource manner of a game. However, in the present disclosure, energy is defined as a resource for playing a card by a player, and the energy of a corresponding value marked on the card needs to be consumed when a card is played.

Item: In an auto chess, each piece generally may wear 3 items (or another quantity of items), and the items may provide a hero with attributes or effects such as attack force, defense power, a hit point, treatment, penetration, and a shield. In the related art, an auto chess game usually has a jungle-clearing section. After defeating a jungle monster, a player obtains an item dropped by the jungle monster and picks up the item into a backpack. Moreover, the item may also be synthesized from components, so as to obtain a higher-quality item.

Chess player: It refers to a virtual character played by a player. Each chess player has different special abilities, which can help the player play a game better.

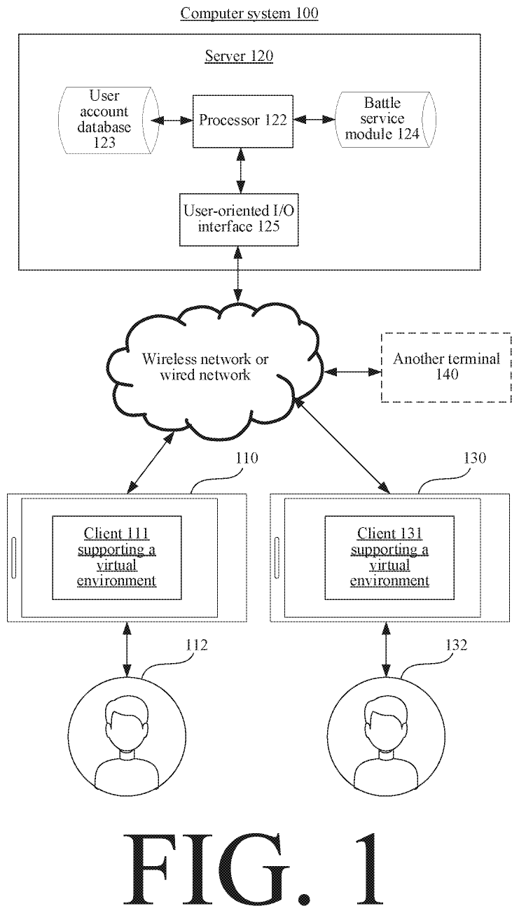

FIG. 1 is a structural block diagram of a computer system according to an exemplary embodiment of the present disclosure. The computer system 100 includes a first terminal 110, a server 120, and a second terminal 130.

The first terminal 110 has a client 111 supporting a virtual environment installed and running therein. The client 111 may be a client of a turn-based board game program. When the first terminal runs the client 111, a user interface of the client 111 is displayed on a screen of the first terminal 110. The client may be a client of an auto chess game. The first terminal 110 is a terminal used by a first user 112. The first user 112 uses the first terminal 110 to deploy pieces in a battle area of a board in a preparation stage of a battle. The first terminal 110 or the server 120 automatically controls the pieces to battle in a battle stage based on an attribute, a skill, and a placement of the pieces in the battle area. The second terminal 130 has a client 131 supporting a virtual environment installed and running therein. The client 131 may be a client of a turn-based board game program. When the second terminal 130 runs the client 131, a user interface of the client 131 is displayed on a screen of the second terminal 130. The client may be a client of an auto chess game. The second terminal 130 is a terminal used by a second user 132. The second user 132 uses the second terminal 130 to deploy the pieces in the battle area of the board in the preparation stage of the battle. The second terminal 130 or the server 120 automatically controls the pieces to battle in the battle stage based on the attribute, the skill, and the placement of the pieces in the battle area. In some embodiments, the pieces deployed by the first user through the first terminal 110 and deployed by the second user through the second terminal 130 are located in different battle areas on the same board. In other words, the first user and the second user are located in the same board of the same battle. Alternatively, the pieces deployed by the first user through the first terminal 110 and deployed by the second user through the second terminal 130 are located on different boards. In other words, the first user and the second user are located in different boards of the same battle. In an exemplary embodiment, six user accounts participate in a battle of the turn-based board game. The six user accounts are matched in pairs in each turn, and the two matched user accounts battle on the same board in a current round.

In some embodiments, the client installed in the first terminal 110 is same as the client installed in the second terminal 130, or the clients installed in the two terminals are clients of the same type on different operating system platforms (Android or IOS). The first terminal 110 may be one of a plurality of terminals, and the second terminal 130 may be another of the plurality of terminals. In this embodiment, only the first terminal 110 and the second terminal 130 are used as an example for description. The first terminal 110 and the second terminal 130 are of the same device type or different device types. The device type includes at least one of a smartphone, a tablet computer, an e-book reader, a moving picture experts group audio layer III (MP3) player, a moving picture experts group 4 (MP4) player, a laptop computer, or a desktop computer. In the following embodiment, a description is provided by using an example in which the terminal includes the smartphone. A person skilled in the art may understand there may be more or fewer terminals. For example, there may be only one terminal (i.e., the user battles against artificial intelligence), or there may be 6 terminals, 8 terminals, or more terminals. A quantity of terminals and the device type are not limited in the embodiments of the present disclosure.

FIG. 1 shows only two terminals. However, in a different embodiment, a plurality of other terminals 140 exist and may be connected to the server 120. In some embodiments, one or more terminals 140 corresponding to a developer alternatively exist. A development and editing platform of the client supporting the virtual environment is installed on each of the terminals 140. The developer may edit and update the client on the terminals 140, and transmit an updated client installation package to the server 120 through a wired or wireless network. The first terminal 110 and the second terminal 130 may download the client installation package from the server 120 to update the client. The first terminal 110, the second terminal 130, and the other terminals 140 are connected to the server 120 through a wired network or a wireless network.

The server 120 includes at least one of one server, a plurality of servers, a cloud computing platform, or a virtualization center. The server 120 is configured to provide a backend service for the client supporting the 3D virtual environment (a client of the turn-based board game/a client of the auto chess game). In some embodiments, the server 120 is in charge of main calculation, and the terminal is in charge of secondary calculation. Alternatively, the server 120 is in charge of secondary calculation, and the terminal is in charge of main calculation. Alternatively, a distributed computing architecture is used between the server 120 and the terminal to perform collaborative computing. In an exemplary example, the server 120 includes a processor 122, a user account database 123, a battle service module 124, and a user-oriented input/output interface (I/O interface) 125. The processor 122 is configured to load instructions stored in the server 120, and process data in the user account database 123 and the battle service module 124. The user account database 123 is configured to store data of user accounts used by the first terminal 110, the second terminal 130, and the other terminals 140, for example, avatars of the user accounts, nicknames of the user accounts, combat effectiveness indices of the user accounts, and service regions where the user accounts are located. The battle service module 124 is configured to provide a plurality of battle rooms for users to battle. The user-oriented I/O interface 125 is configured to establish communication with the first terminal 110 and/or the second terminal 130 through the wireless network or the wired network to exchange data.

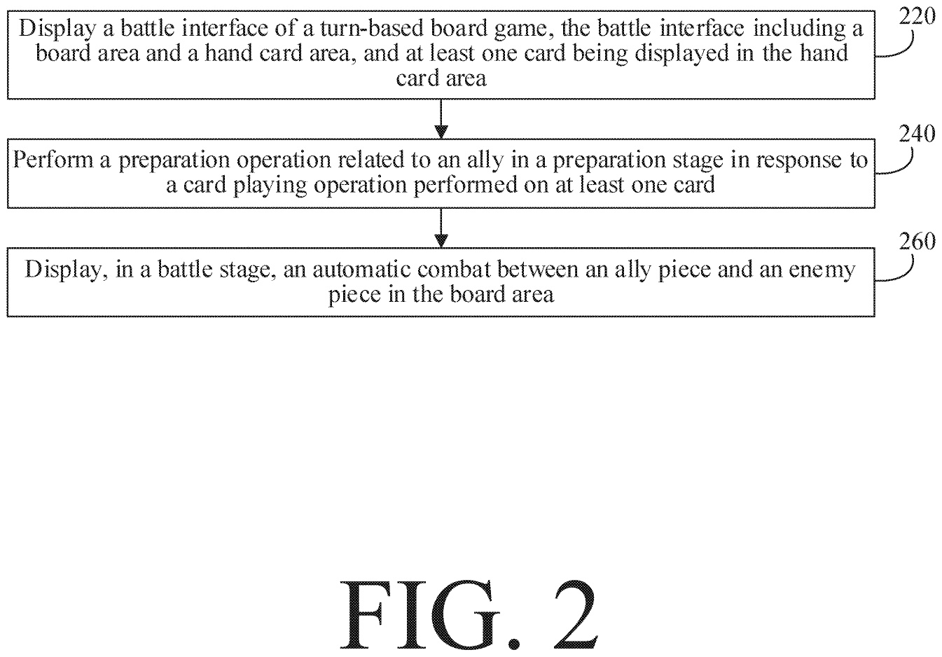

The embodiments of the present disclosure provide a turn-based board game (auto chess) based on a card operation. A plurality of complex operations such as store purchase, store upgrade, piece preparation, piece deployment, piece upgrade, and a piece item involved in conventional auto chess are all simplified in a card playing procedure. According to an aspect, a card-based playing procedure is relatively simple, and is suitable for use on a small-screen terminal such as a mobile phone or a tablet computer. According to another aspect, a 3D model of the virtual pieces can carry only limited literal information, while the card can carry more information such as a “label”, a “value”, an “attribute”, and an “entry effect” on a card surface, thereby improving utilization efficiency of a display area where the card is located. FIG. 2 is a flowchart of a battle interaction method for a turn-based board game according to an exemplary embodiment of the present disclosure. In this embodiment, a description is provided by using an example in which the method is performed by a terminal. The terminal has a client supporting the turn-based board game installed and running therein. The method includes the following operations.

Operation 220: Display a battle interface of the turn-based board game, the battle interface including a board area and a hand card area, and at least one card being displayed in the hand card area.

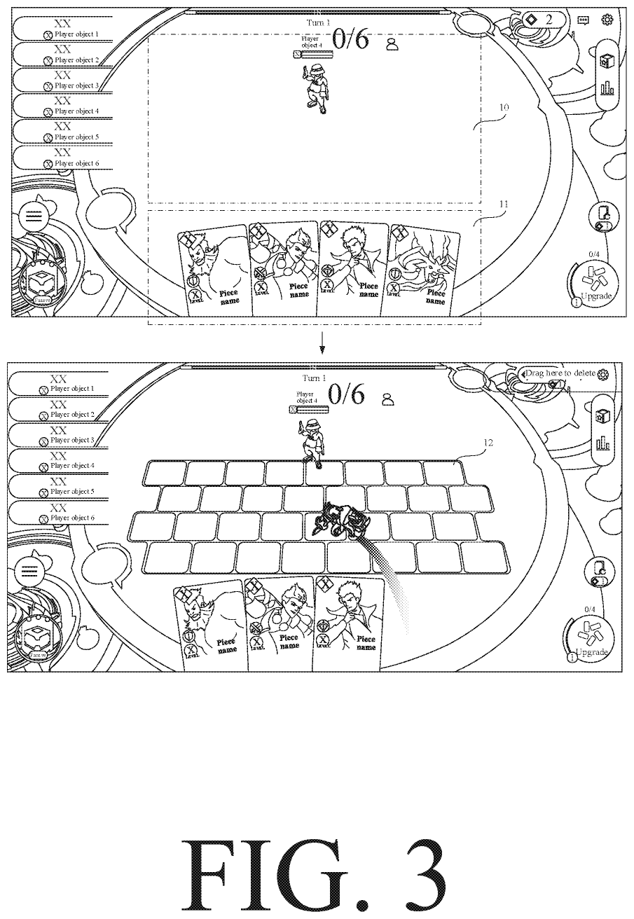

The battle interface is an interface through which two player objects perform a turn-based battle in the turn-based board game. The player object may be understood as at least one concept of a user, an account, a player, a chess player, or a virtual chess player. With reference to FIG. 3, the battle interface includes a board area 10 and a hand card area 11. The board area 10 is configured for accommodating at least one ally piece and at least one enemy piece participating in a battle. The board area 10 includes a plurality of squares 12 deployed in an array, and these squares 12 are always displayed or are displayed only in some occasions. In some embodiments, the board area 10 is a 2D board or a 3D board. In this embodiment, a description is provided by using an example in which the board area 10 is the 3D board viewed from above. The 3D board in this specification refers to a board located in a 3D environment, rather than the board that is certainly in a 3D form. The hand card area 11 is configured for displaying at least one card held or delivered by an ally player object. The at least one card is usually a plurality of cards. The at least one card includes at least one of a card automatically drawn or distributed by a backend program to the ally player object, a card obtained after some cards having a draw effect are played, and a chess player card obtained due to a chess player skill. The plurality of cards has a quantity upper limit, for example, a maximum of 8 cards, and redundant cards are automatically discarded.

In some embodiments, the plurality of cards are arranged in the hand card area 11 in a shape of a fan, and an arrangement sequence may be determined based on at least one factor of a draw time, a card type, a number of cards of the same type, a number of copies of the same card, or a level of card quality. In some embodiments, the at least one card held by the ally player object has an upper limit, for example, a maximum of 8 or 10 cards. When the upper limit is exceeded, the redundant cards are discarded. The ally player object may play all or some cards in each battle turn. In some embodiments, the ally player object may further replace all or some cards in each battle turn. In some embodiments, different cards have different card types. Different card types have different preparation functions.

A battle in the turn-based board game includes a plurality of turns. Each turn includes a preparation stage and a battle stage.

Operation 240: Perform a preparation operation related to an ally in a preparation stage in response to a card playing operation performed on at least one card.

The card playing operation is an operation of playing one or more held cards. Exemplarily, the card playing operation is an operation of dragging a selected card toward the board area. Alternatively, the card playing operation includes a first clicking operation and a second clicking operation. The first clicking operation is an operation of clicking to select a card, and the second clicking operation is an operation of clicking a square in the board area. A specific form of the card playing operation is not limited in the embodiments of the present disclosure. In some embodiments, a function of intelligently recommending to play a card may be further provided, to play a card in place of the ally player object in some turns. For example, for a novice player, the client may intelligently recommend and play the card during several initial turns. The at least one ally piece is a virtual piece participating in a battle in at least one turn (including this turn). When the board area is a 2D board, the virtual piece is also a 2D piece, and is displayed as a 2D icon or 2D image. When the board area is a 3D board, the virtual piece is also a 3D piece, and is displayed as a 3D model or a 3D image. In an initial state, there may be zero ally pieces located in the board area, and the ally piece is added, deleted, or replenished by the ally player object in the board area. An ally piece that has not been killed in a previous turn may be automatically inherited into a next turn.

A display state of a selected card is different from a display state of an unselected card. In some embodiments, the selected card has a highlighting effect. The highlighting effect includes: a bold border, a glowing border, a dynamic border, or moving the placement position in a card queue toward the board area by a preset distance. The preparation operation includes at least one of the following: adding an ally piece, reducing an ally piece, upgrading an ally piece, adding an item to an ally piece, reducing an item from an ally piece, or adding a gain effect to an ally piece.

Because different card types have different effects, the preparation operation is performed on at least one ally piece in the board area based on the card type of the selected card. In the preparation stage, the ally player object prepares the at least one ally piece in the board area, and the enemy player object prepares the at least one enemy piece in the board area.

The character formation method in a virtual scene provided in the present disclosure is a character formation method for the at least one ally piece prepared by the ally player object in the board area in the preparation stage. The method is configured for moving the at least one ally piece in the preparation to a corresponding square in the battle area to form a first placement, so as to improve a win probability of the ally player.

Operation 260: Display, in a battle stage, an automatic combat between an ally piece and an enemy piece in the board area.

An automatic combat process between the ally piece and the enemy piece in the board area does not require manual control by the ally player object. The client or the server automatically controls the pieces of both sides to battle against each other until all pieces of one side are killed based on factors such as positions of the pieces of both sides on squares of the board, attributes of the pieces, levels of the pieces, skills of the pieces, and joint enhancement attributes between the pieces. Both the ally player object and the enemy player object have hit points. After this turn ends, part of values of the hit point are ducted from the defeated player object. The part of values may be determined based on a quantity of pieces remaining by the winner, or may be fixed values. This is not limited in this embodiment.

Based on the above, according to the method provided in this embodiment, a “card” mechanism is introduced into the turn-based board game, the plurality of preparation operations are simplified and integrated in a process of playing a plurality of cards, and a store concept is eliminated. The player does not need to obtain, upgrade, and engage in the battle with the pieces based on a plurality of interactions between a plurality of sub-areas such as the store, the piece preparation area, and the piece battle area on a conventional battle interface. A conventional piece purchase process that needs the user to actively select the pieces is changed to passively receive a dealt card. A game system takes over some complex operations of the user, and the user can complete the plurality of preparation operations only by performing the card playing operations substantially the same as those of a card game, thereby improving human-computer interaction efficiency.

In particular, when the turn-based board game is operated on a small-screen terminal such as a mobile phone or a tablet computer, the player may complete the plurality of preparation operations based on limited operations in the hand card area, which can significantly improve the human-computer interaction efficiency compared with the conventional auto chess game.

Division of card types: In some embodiments, the card types include at least one of a piece card, an effect card, an item card, or a chess player card.

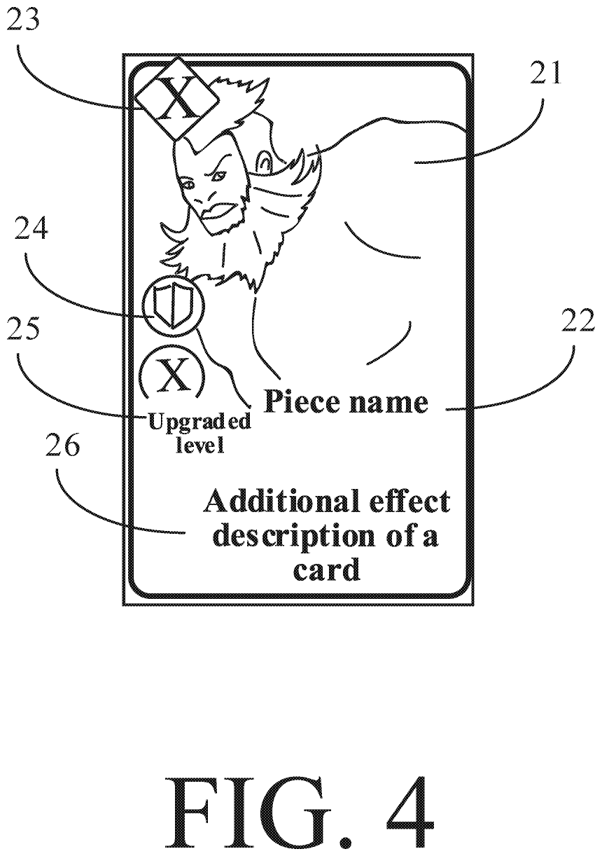

Piece card: It is a card configured for summoning an ally piece or upgrade a piece level of the ally piece in the board area. FIG. 4 is a schematic diagram of a piece card. The piece card displays at least one item of the following information: a piece image 21, a piece name 22, an energy value 23 consumed when the card is played, a piece type or a camp 24 to which the piece belongs, a level 25 by which the piece is increased after the card is played, or an additional effect description 26 of the piece.

The piece image 21 may be at least one of an avatar, an icon, a half-length portrait, a full-length portrait, or a presentation animation of a virtual piece. In FIG. 4, a description is provided by using an example in which the piece image 21 is the half-length portrait of the virtual piece.

The piece name 22 is a name of the virtual piece. Using an example in which the virtual piece is a hero, the piece name is a hero name.

The energy value 23 refers to an energy value consumed when the piece card is played, and the energy value is an integer. Energy is a resource in the turn-based board game. In some embodiments, cards of different qualities need to consume different amounts of energy when the cards are played. For example, the cards of five different qualities need to consume 0, 1, 2, and 3, and 4 points of energy when the cards are played.

The piece type 24 is a division attribute of a character played by a piece in a battle process. In an example, different pieces may be divided into at least one piece type of a tank, a warrior, an assassin, a mage, a shooter, and a support. A camp is a division attribute that indicates pieces belong to the same piece group in a virtual world view. In an example, the different pieces may be divided into at least one of the following: Great Wall, Three-Point Land, Xuanyong, Mechanisms, Yaotian, or Chang'an. For example, in the virtual world view, 2 pieces that are both The Great Wall guards belong to the Great Wall camp. In different embodiments, the piece type and the camp may be considered as the same division attribute. In this embodiment, an example in which the piece type and the camp are different division attributes is used. The level 25 by which the piece is increased after the card is played refers to an upgraded level for a piece having the same name (that is, the same piece) after the card is played when the piece has existed in the board area. For example, the level 25 is a level 3,and an original level of the piece with the same name is a level 2. In this case, the piece with the same name is upgraded to a level 5 after the card is played. In some embodiments, the cards of different qualities upgrade the pieces with the same name by different levels after being played. For example, the cards of five different qualities upgrade the pieces with the same name by levels 1, 2, 3, 4, and 5 respectively after be played.

The additional effect description 26 of the piece is an effect description of an additional effect of the piece. The additional effect may be triggered to take effect when the card is played, or may be brought to take effect when a trigger condition is satisfied in the battle process. For example, an exclusive skill of a piece 1 is as follows. When the piece 1 is present, each time another ally piece in the board area is sold, an ally piece present on the board with the piece type “tank” is randomly selected, and the level of the randomly selected ally piece is increased by a first value. The first value is half the level of the piece to be sold.

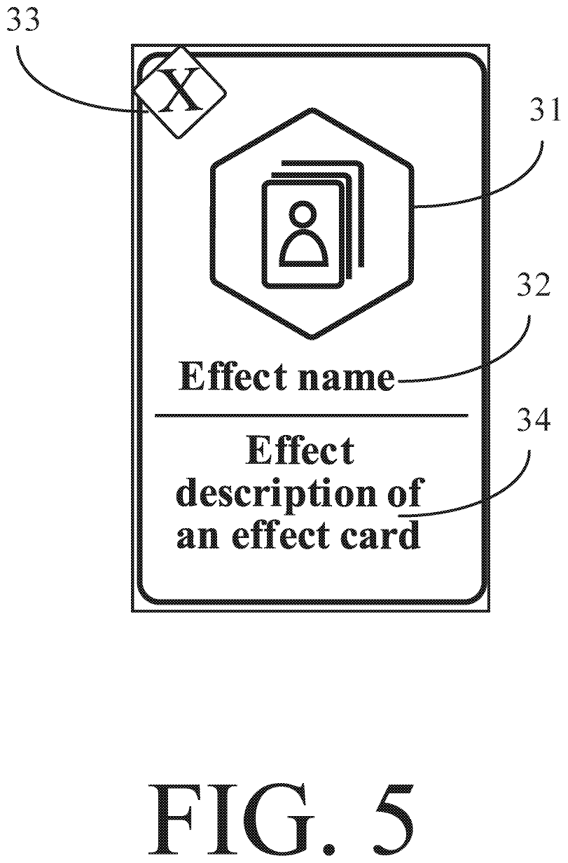

Effect card: It is a card configured for applying an effect to at least one game factor in a game battle. The at least one game factor includes a piece, a skill, an item, a gain effect, a level, a battle process, a drawing process, and the like. FIG. 5 is a schematic diagram of an effect card. The effect card displays at least one item of the following information: an effect icon 31, an effect name 32, an energy value 33 consumed when a card is played, and an effect description 34 of the effect card.

The effect icon 31 may be an icon configured for representing a gain effect of the effect card. In FIG. 5, an icon with a hexagon outline is used as an example for illustration. The effect name 32 is a name of the effect card or a name of the gain effect.

The energy value 33 is an energy value consumed when the effect card is played, and the energy value is an integer. Energy is a resource in the turn-based board game. In some embodiments, cards of different qualities need to consume different amounts of energy when the cards are played. For example, the cards of five different qualities need to consume 0, 1, 2, and 3, and 4 points of energy when the cards are played.

The effect description 34 of the effect card is configured for describing an effect of the effect card after the effect card is used. The effect of the effect card includes, but is not limited to, at least one of the following. 1. A probability and/or a quantity of the piece cards obtained by the ally chess player are increased. 2. A probability or a quantity of the piece cards with the same name associated with the pieces on the board obtained by the ally chess player are increased. 3. The energy required for obtaining the piece card by the ally chess player is reduced. 4. The quantity of the piece cards the ally chess player can exchange is increased. 5. The energy required by the ally chess player to exchange for the piece card is reduced. 6. The level of at least one piece on the board is increased. 7. An item is added for at least one piece on the board. 8. An item level for at least one piece on the board is increased. 9. The energy consumed during card playing/card replacement is reduced. 10. A probability of obtaining cards is increased. 11. A quantity of obtained cards is increased. 12. A card replacement opportunity is increased, and the like. Details are not described herein again.

For example, an effect of a “double” card is randomly obtaining 2 copies of the same hero card; an effect of a “talent search” card is choosing 1 out of 3 hero cards of the highest quality that can be obtained under a current chess player level; an effect of a “copying” card is randomly obtaining 1 card with the same name as a hero on the board; an effect of an “abundant harvest” card is immediately replenishing the cards in hand to 5; an effect of a “random enhancement” card is randomly upgrading 1 hero on the board by +5 levels; an effect of an “another time” card is drawing 1 card, and obtaining 1 additional free card replacement in this turn; an effect of a “prayer” card is reducing the energy value consumed by all cards by −1; and an effect of an “adding” card is drawing 2 cards. In some embodiments, the effect card may be divided into at least one of a universal effect card, a piece type effect card, or a camp effect card. The universal effect card is an effect card whose card attribute is unrelated to a piece type/camp, and the card attribute includes at least one of an obtaining condition, a use condition, a card effect, and an effect range. The piece type effect card is an effect card whose card attribute is related to the piece type, for example, a card whose effect can be obtained, used, or enjoyed only by a piece of a specified piece type. The camp effect card is an effect card whose card attribute is related to a camp, for example, a card whose effect can be obtained, used, or enjoyed only by a piece of a specified camp. For example, a piece type effect card may be obtained at a probability only when a piece card of the piece type is played.

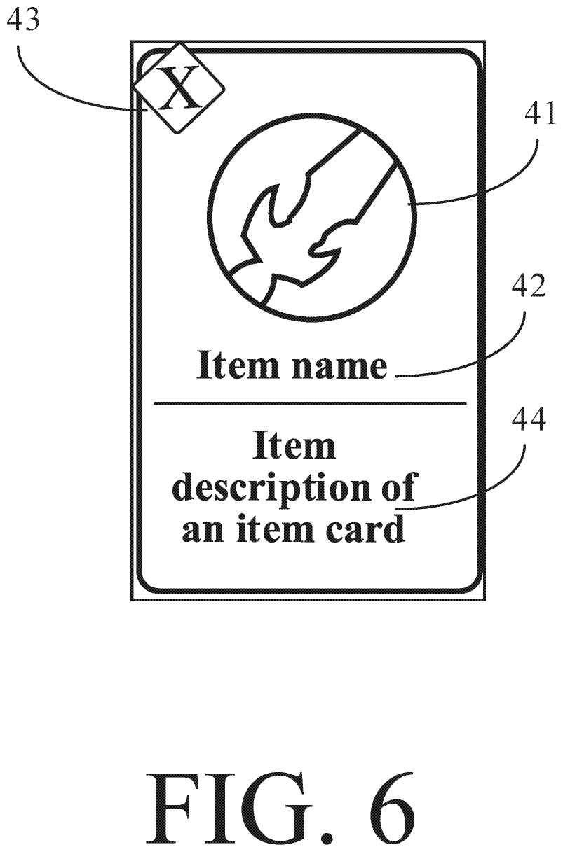

Item card: It is a card configured for wearing an item for at least one ally piece. FIG. 6 is a schematic diagram of an item card according to an exemplary embodiment of the present disclosure. The item card displays at least one item of the following information: an item icon 41, an item name 42, an energy value 43 consumed when a card is played, or an item description 44 of an item card.

The item icon 41 may be an icon configured for representing an item image or an item effect. In FIG. 6, an icon with a circular outline is used as an example for illustration. The item name 42 is a name of the item card or a name of an item. A different item may enhance a combat capability of the ally piece or reduce the combat capability of the enemy piece in different dimensions such as a blood volume, an armor, a defense, and a magic point. The energy value 43 is an energy value consumed when the item card is played, and the energy value is an integer. Energy is a resource in the turn-based board game. In some embodiments, cards of different qualities need to consume different amounts of energy when the cards are played. For example, the cards of five different qualities need to consume 0, 1, 2, and 3, and 4 points of energy when the cards are played. In some embodiments, the energy values consumed by different cards may be periodically or aperiodically adjusted based on game balance. The item description 44 of the item card is configured for describing the effect of the item after the item is worn.

Chess player card: It is a card obtained through a chess player skill of a virtual chess player character. The chess player card may be a card obtained by triggering a passive skill of the virtual character of the chess player, a card that can be obtained by only the virtual character of the chess player, a card that can be used by only the virtual character of the chess player, a card exclusive to only the virtual character of the chess player, or the like. This is not limited in the embodiments of the present disclosure.

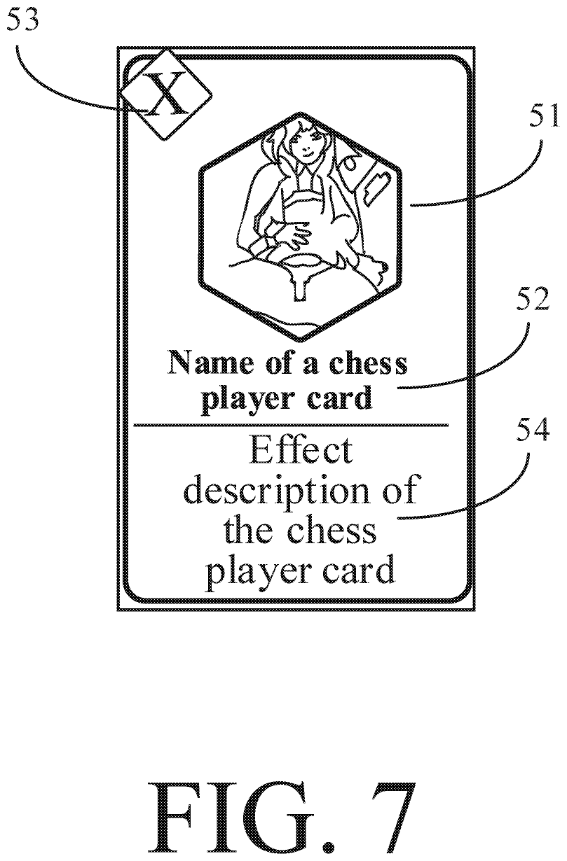

FIG. 7 is a schematic diagram of a chess player card according to an exemplary embodiment of the present disclosure. The chess player card displays at least one item of the following information: a card icon 51, a chess player card name 52, an energy value 53 consumed when a card is played, or an item description 54 of the chess player card. The card icon 51 may be an icon configured for representing a card effect. In FIG. 7, an icon with a hexagon outline is used as an example for illustration. The chess player card name 52 is a name of the chess player card or a name of the effect.

The energy value 53 is an energy value consumed when the chess player card is played, and the energy value is an integer. Energy is a resource in the turn-based board game. In some embodiments, cards of different qualities need to consume different amounts of energy when the cards are played. For example, the cards of five different qualities need to consume 0, 1, 2, and 3, and 4 points of energy when the cards are played. In some embodiments, the energy values consumed by different cards may be periodically or aperiodically adjusted based on game balance. The effect description 54 of the chess player card is configured for describing an effect that the chess player card can increase after the chess player card is used. The effect of the chess player card may be the same as or similar to effects of a piece card, an item card, and an effect card, and may also exceed effect scopes of the piece card, the item card, and the effect card. In possible designs of different embodiments, the effect of the chess player card may be designed in any effect form such as summoning pieces, upgrading pieces, adding an item, adding a gain effect, reducing energy consumption, and affecting a drawing process. The effect of the chess player card may be designed to affect any process or detail in a game battle. This is not limited in the embodiments of the present disclosure.

It can be known based on the introduction of the foregoing four types of cards that, according to an aspect, different types of cards have different functions. The piece card may be configured for canceling the store in the conventional auto chess based on a gameplay attribute of the card, the effect card may be configured for canceling an effect button or a control in the conventional auto chess, the item card may be configured for canceling a jungle-clearing stage in the conventional auto chess, and the chess player card may be configured for integrating the gameplay attribute related to the chess player. Based on different types of cards, different mechanisms in the turn-based board game are simplified to a card playing process. In other words, user interface elements needing to be displayed on a battle interface can be reduced, and operation difficulty of the ally player object can be simplified, thereby improving human-computer interaction efficiency of the ally player object. According to another aspect, compared with a 2D card, 3D pieces cannot well carry literal information because the 3D pieces can only carry limited literal information. However, a card feature of the 2D card can naturally carry more literal information and icon information, so that compared with the 3D pieces in a conventional preparation stage, the 2D card can further improve an amount of information carried in a limited display range on a terminal with a small screen, thereby improving information delivery efficiency. The foregoing cards not only can be played in the preparation stage, but also some cards can be played in the battle stage. For example, for some item cards, effect cards of 2 more cards are drawn at once.

Card obtaining method: When an obtaining condition is satisfied, the ally player object obtains at least one card. The obtaining condition includes at least one of the following.

Obtaining condition 1: A new round of turn-based combat is started. Each time the new round of turn-based combat is started, several cards are obtained. For example, 4 cards are drawn in a first round of turn-based combat, and 2 cards are drawn in a subsequent round of turn-based combat. Obtaining condition 2: A preset piece card is used. The preset piece card is a piece card having additional skills such as drawing, adding, or copying a card. For example, an effect card is additionally obtained during playing of a piece card with the same name corresponding to a current piece. Obtaining condition 3: A preset effect card is used. The preset effect card is an effect card having an effect such as drawing, adding, or copying a card. Obtaining condition 4: A preset chess player card is used. The preset chess player card is an effect card having an effect such as drawing, adding, or copying a card. Obtaining condition 5: A resource owned by the ally is consumed for an exchange. For example, energy is consumed for a draw or an exchange. Obtaining condition 6: A chess player level of a virtual characters of the chess player is upgraded. After the player level is upgraded, cards of higher quality or a larger quantity may be obtained through unlocking. Obtaining condition 7: A card pool level is upgraded. After the card pool level is upgraded, cards of higher quality or a larger quantity may be obtained through unlocking. Obtaining condition 8: An operation of purchasing a card is performed. Obtaining condition 9: A preset chess player skill is triggered. The preset chess player skill refers to a passive skill having an action effect such as drawing, adding, or copying a card. For example, one chess player card may be drawn every 2 turns, and one chess player card may be drawn each time 3 cards are played.

The obtaining conditions may be combined. For example, some cards can only be obtained by using a preset chess player card after the chess player level reaches a level 2.The obtaining conditions for different types of cards may be completely different, or may be completely the same, or some conditions may be the same and some conditions may be different.

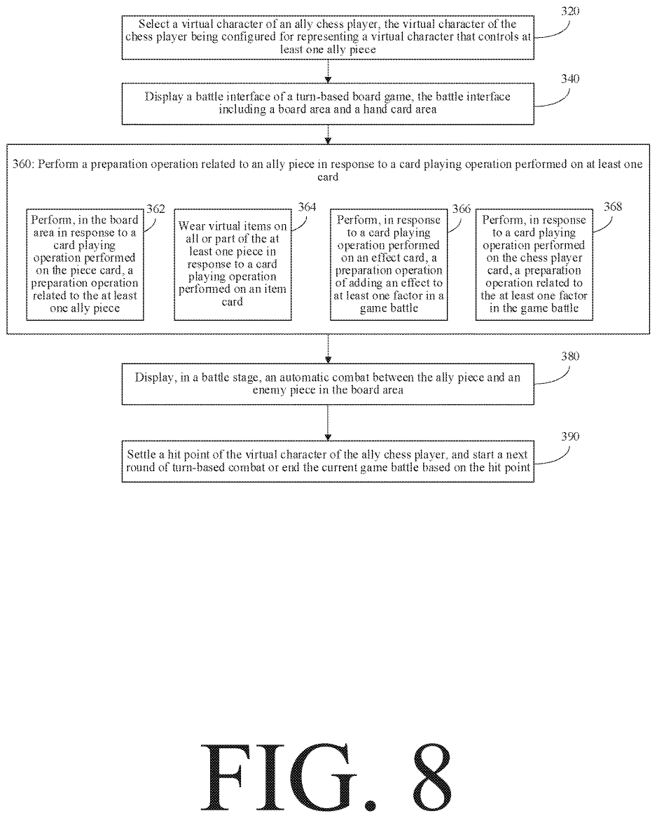

FIG. 8 is a flowchart of a battle interaction method for a turn-based board game according to an exemplary embodiment of the present disclosure. In this embodiment, a description is provided by using an example in which the method is performed by a terminal. The method includes the following operations.

In a chess player selection stage, operation 320: Select a virtual character of an ally chess player, the virtual character of the chess player being configured for representing a virtual character that controls at least one ally piece.

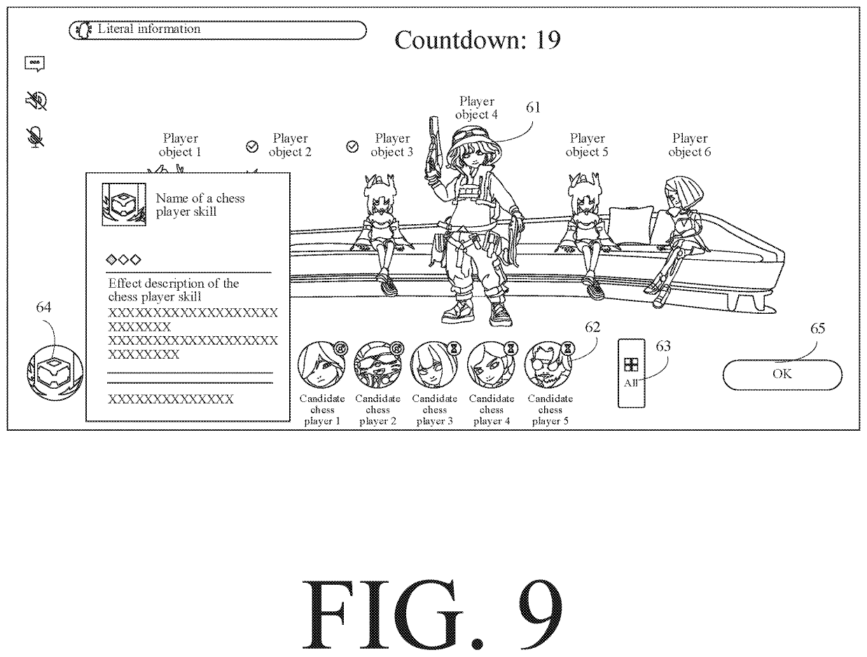

Before starting a game battle each time, the ally player object selects a desired virtual character of the chess player. Different virtual characters of the chess player have different chess player skills. A chess player skill is usually related to obtaining a chess player card, but may also be related to another game factor. In some embodiments, for different chess player skills, there are some respective passive trigger mechanisms to enable the ally player object to obtain some cards with special effects. For example, a skill effect of a chess player is as follows. One treasure chess player card is obtained each time 3 piece cards are played, and an effect of the treasure chess player card is as follows. 1 point of energy is consumed, and a level of an ally piece in the board area is specified to be increased by 2. For example, as shown in FIG. 9, before a game battle is started, a chess player selection interface is displayed. The chess player selection interface displays the virtual characters of the chess player selected by 6 player objects. In some embodiments, a virtual character 61 of the chess player selected by the ally player object is highlighted. An example in which the ally player object is a player object 4 is used. The virtual character of the chess player selected by the player object 4 is highlighted in a manner of standing, magnifying, and centering in a foreground, and the virtual character of the chess player selected by another player object is conventionally displayed in a manner of sitting, a normal size, and being distributed on two sides.

Several candidate virtual characters of the chess player 62, for example, candidate chess players 1 to 5, are displayed on the chess player selection interface. Another candidate chess player may be viewed by swiping left and right, or all candidate chess players may be viewed by clicking an “all” button 63.

A chess player skill button 64 is further displayed on the chess player selection interface. In response to that the chess player skill button 64 is clicked/tapped, a skill name and an effect description of a chess player skill of the currently selected virtual character of the chess player may be viewed in a right pop-up window.

In some embodiments, a message sent by another player and a countdown for selecting a chess player or entering a battle are displayed at a top of the chess player selection interface. A text message sending button, a speaker off/on button, and a microphone off/on button are displayed on a left side of the chess player selection interface. After the virtual character of the chess player selected by the ally player object is determined, a “OK” button 65 may be clicked/tapped to enter a preparation state. n player objects participating in a round of game battle perform a turn-based combat between each other. Each turn includes a preparation stage and a battle stage.

In a preparation stage of each turn, operation 340: Display the battle interface of the turn-based board game, the battle interface including the board area and the hand card area.

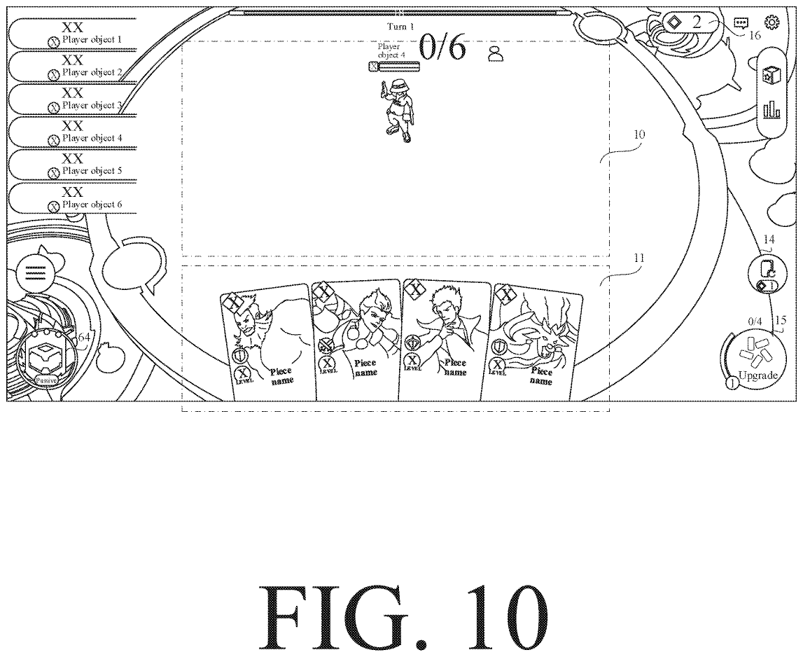

With reference to FIG. 10, the board area 10 is configured for placing at least one ally piece and at least one enemy piece. In some embodiments, an upper half of the board area 10 is configured for placing at least one enemy piece, and a lower half of the board area 10 is configured for placing at least one ally piece. The hand card area 11 is configured for displaying at least one card held by the ally player object. In an initial state or in some cases (for example, all cards in a current turn are played), a quantity of cards displayed in the hand card area 11 is 0.

In some embodiments, attribute information of n player objects participating in the current game battle is further displayed at an upper left corner of the battle interface. The attribute information includes at least one of a player nickname, a player avatar, a blood volume of a player, and a chess player level of a player. The chess player skill button 64 is displayed at a lower left corner of the battle interface. A card change button 14 and an upgrade button 15 are further displayed at a lower right corner of the battle interface. The card change button 14 is configured to replace one or more cards in the hand card area 11. The upgrade button 15 is configured to upgrade the level of the virtual character of the chess player, to unlock a higher-level card and capability, and obtain an item.

In some embodiments, an energy control 16 is further displayed at an upper right corner of the battle interface, and the energy control 16 is configured to display an energy value possessed by the ally player object. Energy is a game resource that may be required at various stages of an entire game battle. For example, playing the card needs to consume energy, replacing the card needs to consume energy, and upgrading the chess player level needs to consume energy.

Operation 360: Perform a preparation operation related to an ally piece in response to a card playing operation performed on at least one card.

The card type includes at least one of a piece card, an item card, an effect card, or a chess player card. The ally player object may perform preparation operations with different functions by performing the card playing operation on different piece cards. This operation includes at least one of the following operations. Operation 362: Perform, in the board area in response to the card playing operation on the piece card, a preparation operation related to at least one ally piece. Operation 364: Wear virtual items on all or part of the at least one piece in response to a card playing operation performed on an item card. Operation 366: Perform, in response to a card playing operation on an effect card, a preparation operation of adding an effect to at least one factor in a game battle. Operation 368: Perform, in response to a card playing operation on the chess player card, a preparation operation related to the at least one factor in the game battle.

Because each round of turn-based combat has a different battle situation, each player object has a different hand of cards, and each player object has a different playstyle, a quantity of times and a sequence of performing operation 362, operation 364, operation 366, and operation 368 in each round of turn-based combat may be changed. This is not limited in this embodiment.

For operation 362 (the piece card), in some embodiments, the card located in the hand card area includes a first piece card. In response to the card playing operation on the first piece card, a first ally piece is added in the board area, where the first ally piece is a piece corresponding to the first piece card. In some embodiments, the first ally piece is a piece not summoned to the board area.

In other words, when the first ally piece does not exist in the board area, the first ally piece is added in the board area in response to the card playing operation on the first piece card.

In response to the card playing operation on the first piece card, at least two candidate squares are displayed in the board area, and a first indication element corresponding to the first piece card is displayed. The first indication element includes at least one of a scaled-down first piece card, a first ally piece, or a first indication arrow. In response to a dragging operation of dragging the first indication element to the first candidate square, the first ally piece is added to the first candidate square. The first candidate square is one of the at least two candidate squares.

The at least two candidate squares may be all candidate squares, or may be the candidate squares only belonging to the ally. The at least two candidate squares may be always displayed, or may be displayed only when the card playing operation is recognized.

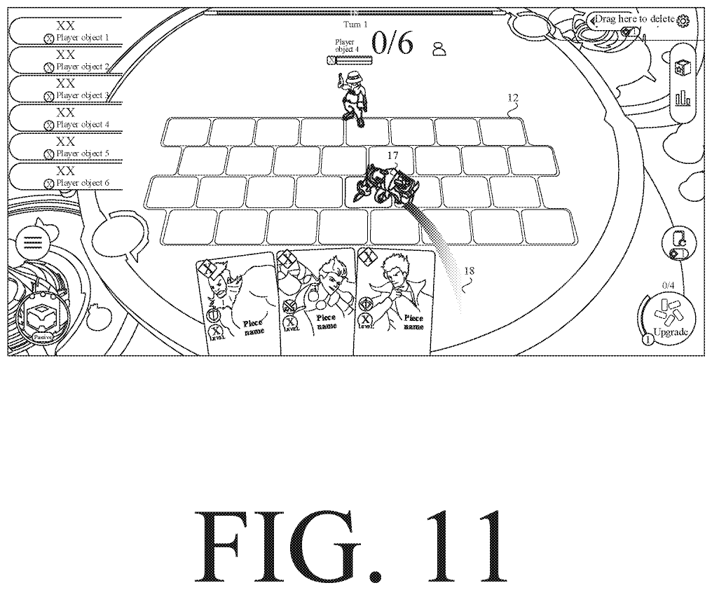

An example in which the first piece card is a 4^{th} card in FIG. 10 is used. With reference to FIG. 11, in response to the dragging operation performed on the first piece card, a first ally piece 17 and a first indication arrow 18 are displayed. The first ally piece 17 is a 3D piece that slides following a real-time position of the dragging operation. A start point of the first indication arrow 18 is a position of the first piece card before being played, and an end point is the real-time position of the dragging operation. When a hand release position of the dragging operation is in the first candidate square, the first ally piece 17 is summoned to the first candidate square. It may be learned based on FIG. 11 that, the interaction manner eliminates the piece preparation area, and both piece obtaining and preparation functions are provided in the hand card area, so that a plurality of functions share one display area to improve human-computer interaction efficiency. In some embodiments, the card located in the hand card area includes a second piece card. In response to the card playing operation performed on the second piece card, and a second ally piece already exists in the board area, the piece level of the second ally piece in the board area is upgraded, where the second ally piece is a piece corresponding to the second piece card. The card playing operation performed on the second piece card may alternatively be the dragging operation. However, because the second ally piece already exists in the board area, the hand release position of the dragging operation may be completed at any position in the board area, and the ally player object does not need to accurately drag the second ally piece to take effect.

For operation 364 (the item card), in some embodiments, the card located in the hand card area includes the item card. In response to the card playing operation performed on the item card, a second indication element corresponding to the item card is displayed. The second indication element includes at least one of a scaled-down item card, a virtual item corresponding to the item card, or a second indication arrow.

In response to the dragging operation of dragging the second indication element to the second ally piece, the virtual item is worn for the second ally piece. The second ally piece is an ally piece already existing in the board area.

For operation 366 (the effect card), in some embodiments, the card located in the hand card area includes the effect card. In response to the card playing operation on the effect card, an effect is added to at least one ally piece, and/or an effect is added to a card obtaining procedure. The effect cards are divided based on action objects, and the effect cards include two types.

Type 1: An effect is added to the ally piece in the board area. Type 2: An effect is added to the card obtaining procedure.

In response to the card playing operation performed on an effect card of type 1, an effect is added to at least one ally piece, for example, a gain exclusive to a piece type is added, or a joint gain when at least two pieces of the same camp are played at the same time is added. In response to the card playing operation performed on an effect card of type 2, an effect is added to the card obtaining procedure. For example, two copies of the same piece cards are drawn consecutively.

For operation 368 (the chess player card), at least one of the following preparation operations is performed in response to the card playing operation performed on the chess player card: adding the ally piece, reducing the ally piece, upgrading the ally piece, adding an effect to the ally piece, wearing a prop for the ally piece, an operation related to card obtaining, an operation related to card sale, an operation related to card exchange, an operation related to a subsequent turn, and an operation related to the hit point of the ally player object.

In other words, a function of the chess player card is special. The function may be any function of the piece card, the item card, and the effect card, may be a function related to the card obtaining procedure, or may be a function related to the hit point of the chess player. In different design implementations, a function that can affect a factor in the game battle may be designed as the function of the chess player card. This is not limited in the embodiments of the present disclosure.

In the preparation stage, the ally player object may further use at least one of a card replacement function, a card removal function, or a chess player level upgrade function.

Card replacement function: In the preparation stage, the ally player object may further exchange one or more cards in the hand card area. One or more cards are replaced by clicking/tapping the card replacement button. Card replacement needs to consume energy. For example, the card can be replaced only once in each turn. A plurality of cards may be replaced at a time, and 1 point of energy is consumed no matter how many cards are replaced.

Card removal function: During card playing, a card may be removed or sold by dragging the card to a specified position. The resource consumed by the removed card may not be recovered or may be partially recycled, or a fixed amount of energy may be recycled. For example, each time a card is removed, 1 point of energy may be obtained.

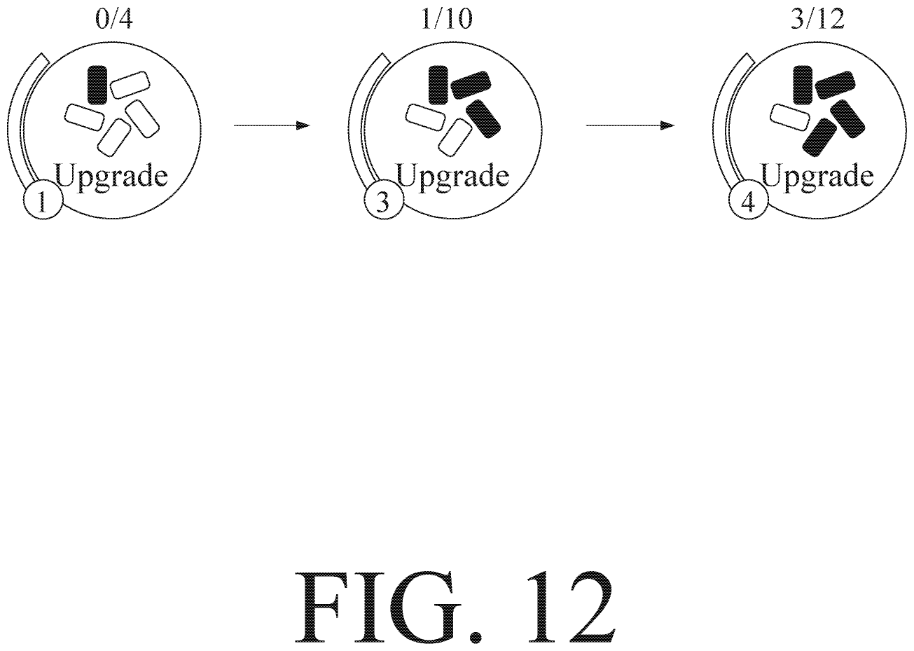

Chess player level upgrade function: The ally player object obtains several pieces of energy in each turn. The energy not used in this turn may be accumulated to a next turn, and the chess player level may be upgraded by using the energy. A higher chess player level indicates that a card of higher quality can be drawn in each turn, and at the same time, some new capabilities, such as talent and a purchasable item, are unlocked. In some embodiments, quality identifiers in different colors may be displayed on the upgrade button 15. As the chess player level is upgraded, the quality identifier corresponding to the current chess player level is lighted up, to indicate the card quality that can be obtained by the current chess player level. The quality identifier may be a small circle containing several rectangles shown in FIG. 12 as an example, or may be in another shape or form.

For example, at the chess player level 1/2/3/4/5, the ally player object respectively unlocks the cards of quality 1/2/3/4/5.

In a battle stage of each turn, operation 380: Display, in a battle stage, an automatic combat between the ally piece and an enemy piece in the board area. An automatic combat process between the ally piece and the enemy piece in the board area does not require manual control by the ally player object. The client or the server automatically controls the pieces of both sides to battle against each other until all pieces of one side are killed based on factors such as positions of the pieces of both sides on squares of the board, attributes of the pieces, levels of the pieces, skills of the pieces, and joint enhancement attributes between the pieces.

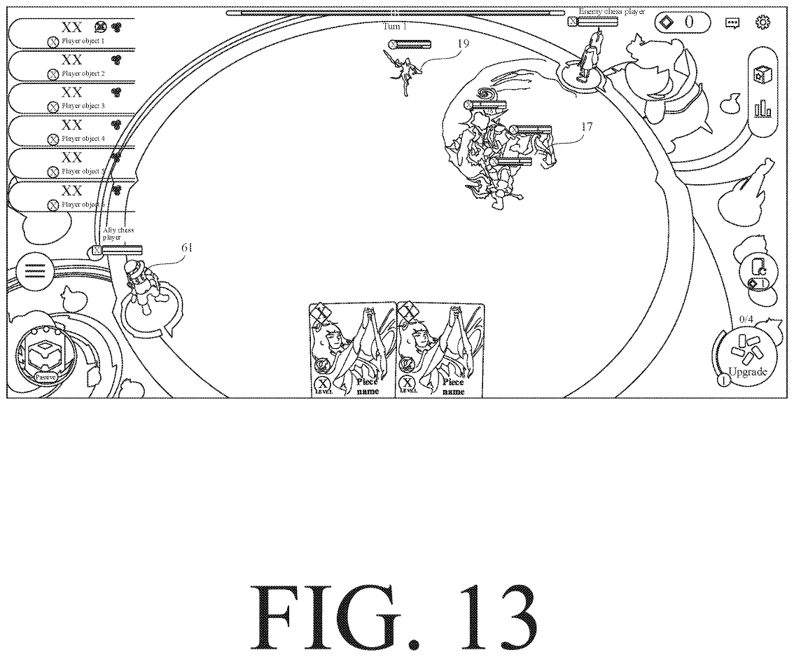

FIG. 13 is a schematic diagram of an automatic combat between an ally piece 17 and an enemy piece 19 in a board area. Actions such as movement, skill casting, and functions of the pieces of both sides during the battle do not need to be manually controlled by the player.

In a combat settlement stage, operation 390: Settle a hit point of the virtual character of the ally chess player, and start a next round of turn-based combat or end the current game battle based on the hit point.

Both the ally player object and the enemy player object have hit points. After this turn ends, part of values of the hit point are ducted from the defeated player object. The part of values may be determined based on a quantity of pieces remaining by the winner, or may be fixed values. This is not limited in this embodiment.

When the hit point is deducted to zero, the player is eliminated from this game battle. When the hit point is not deducted to zero, a next round of the turn-based combat is started in this round of the game battle, and the player continues to battle against one player object of the n player objects until the player is eliminated, or wins this round of the game battle as a last non-eliminated side.

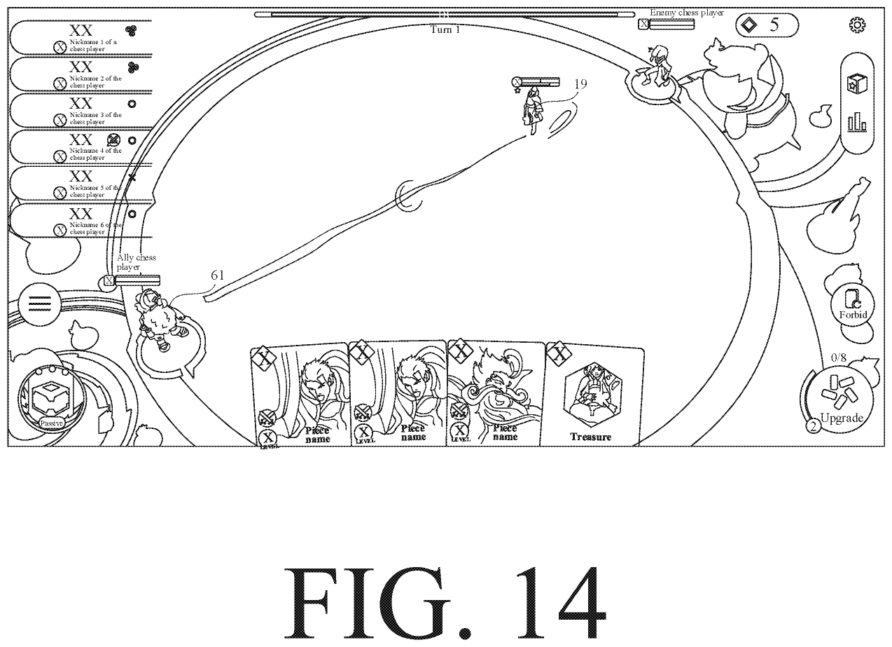

In some embodiments, the settlement of damage is determined based on the quantity of remaining pieces of the winner on the board. FIG. 14 shows an animation effect of settlement of a hit point of a virtual character 61 of the chess player of an ally when an ally is defeated and there is 1 remaining enemy piece 19. A hit point progress bar may be displayed above a head of the virtual character of the chess player 61.

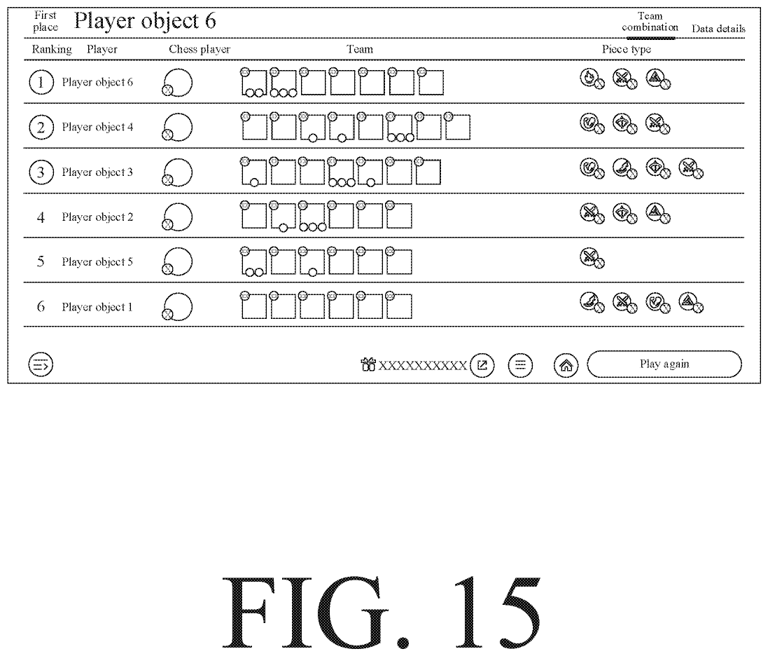

Exemplarily, referring to FIG. 15, a settlement interface displays settlement information of this game battle. The settlement information includes information such as a player ranking, a player, a team, and a piece type used by each chess player.

Based on the above, according to the method provided in this embodiment, a “card” mechanism is introduced into the turn-based board game, the plurality of preparation operations are simplified and integrated in a process of playing a plurality of cards, and a store concept is eliminated. The player does not need to obtain, upgrade, and engage in the battle with the pieces based on a plurality of interactions between a plurality of sub-areas such as the store, the piece preparation area, and the piece battle area on a conventional battle interface. A conventional piece purchase process that needs the user to actively select the pieces is changed to passively receive a dealt card. A game system takes over some complex operations of the user, and the user can complete the plurality of preparation operations only by performing the card playing operations substantially the same as those of a card game, thereby improving human-computer interaction efficiency.

In particular, when the turn-based board game is operated on a small-screen terminal such as a mobile phone or a tablet computer, the player may complete the plurality of preparation operations based on limited operations in the hand card area, which can significantly improve the human-computer interaction efficiency compared with the conventional auto chess game.

According to the method provided in this embodiment, the piece card may be configured for eliminating the store in the conventional auto chess game card based on the gameplay attribute of the card, and the complex process in which the user originally needs to purchase desired pieces in dozens of sellable pieces in the store is changed to a process in which the game system automatically distributes several cards to a player. The user does not need to manually select the card, thereby reducing a quantity of interaction operations required when the user obtains the piece and an amount of information that the user needs to process.

According to the method provided in this embodiment, the effect card may be configured for canceling an effect button or a control in the conventional auto chess, the item card may be configured for canceling a jungle-clearing stage in the conventional auto chess, and the chess player card may be configured for integrating the gameplay attribute related to the chess player. Based on different types of cards, different mechanisms in the turn-based board game are simplified to a card playing process. In other words, user interface elements needing to be displayed on a battle interface can be reduced, and a time spent on actively searching for related function entries by the user can be shortened, and operation difficulty of the ally player object can be simplified, thereby improving human-computer interaction efficiency of the ally player object.

In the character formation method in a virtual scene provided in the embodiments of the present disclosure, before the game battle in each turn, the ally player object performs the card playing operation on at least one piece card in the hand card area, and adds at least one ally piece in the board area. The ally player object may drag each ally piece to any candidate square, or may display the ally piece in a preset area of the board area in response to the card playing operation performed on the piece card, for example, display the ally piece in a square in areas such as the upper left area and the lower right area of the board area. In addition, the ally player object may respectively wear at least one virtual item for at least one ally piece in the board area. The ally player object selects a first placement from at least one recommended team placement and at least one preset placement, and moves the at least one ally piece to a square corresponding to the first placement in response to the operation of selecting the first placement, so as to display, in the board area, the at least one ally piece deployed based on the first placement, thereby achieving a one-tap formation effect on the at least one ally piece.

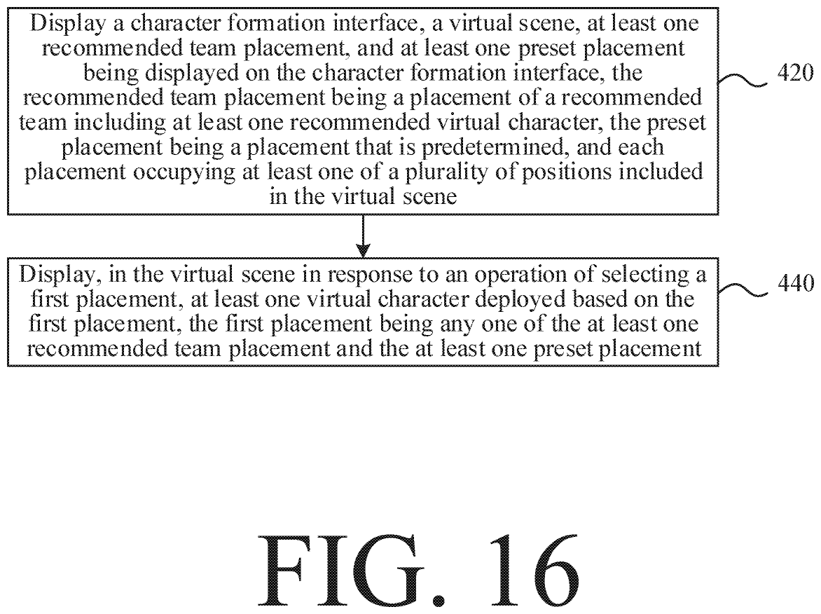

FIG. 16 is a flowchart of a character formation method in a virtual scene according to an embodiment of the present disclosure. Operations of the method may be performed by a terminal device. For example, the terminal device may be the first terminal or the second terminal described above. The method may include at least one operation of operation 420 to operation 440 below.

Operation 420: Display a character formation interface including a virtual scene, at least one recommended team placement, and at least one preset placement. In some embodiments, the recommended team placement may be a placement of a recommended team. The recommended team may include at least one recommended virtual character. In some embodiments, the preset placement may be a placement that is predetermined. In an embodiment, the at least one recommended team placement and the at least one preset placement may occupy at least one of a plurality of positions included in the virtual scene.

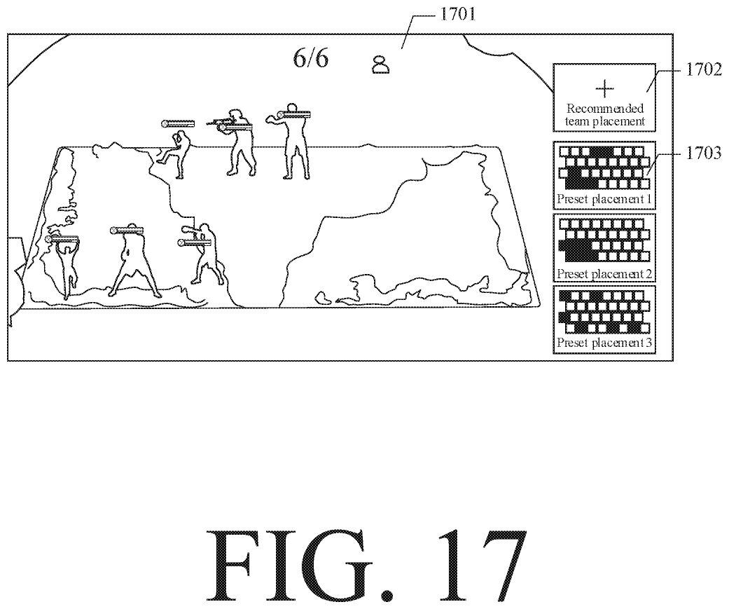

The character formation interface may be an interface in which the virtual scene is observed from a perspective of an ally player object. The virtual scene includes a board area and N to-be-deployed virtual characters (or referred to as N ally pieces). The perspective of the ally player object may be a first perspective of the ally player object, or may be a fixed perspective for the board area. The character formation interface may be a presentation interface of the virtual scene obtained by a virtual camera from the virtual scene. In some embodiments, the virtual camera obtains the presentation interface of the virtual scene from the first perspective of the ally player object. For example, the virtual camera may be arranged right in front of the ally player object. The client observes the virtual scene from the perspective of the ally player object through the virtual camera, and obtains and displays the virtual environment image from the first perspective of the ally player object. In addition, in an exemplary embodiment, a placement position of the virtual camera is adjustable in real time. In some embodiments, the ally player may adjust a position and a focal length of the virtual camera through a touch operation performed on the presentation interface of the virtual scene, to obtain images corresponding to different positions and different focal lengths. For example, the ally player may drag the presentation interface of the virtual scene to adjust the position of the virtual camera. For another example, the ally player may zoom in presentation details of the virtual scene, to adjust the focal length of the virtual camera. In some embodiments, the board area may display only the battle area of the ally and the N to-be-deployed virtual characters located on the battle area of the ally, or may display both the battle area of the ally and the N to-be-deployed virtual characters located on the battle area of the ally, and a battle area of an enemy side and the to-be-deployed virtual characters located on the battle area of the enemy side. The to-be-deployed N to-be-deployed virtual characters refer to virtual characters corresponding to the N piece cards added in the board area in the preparation stage, when a preparation operation related to the ally is performed in response to the card playing operation on the N cards. For a specific implementation process, reference may be made to operation 240. Details are not described herein again. As shown in FIG. 17, a virtual scene 1701, at least one recommended team placement 1702, and at least one preset placement 1703 are displayed on the character formation interface. The placement refers to a square position occupied by each virtual character in the board area, and each placement occupies at least one position (i.e., a square position) in a plurality of positions included in the virtual scene.

The recommended team placement may be a placement of a recommended team including at least one recommended virtual character. The recommended virtual character may be a virtual character forming the recommended team. The recommended team may include at least one recommended virtual character. A quantity of the recommended virtual characters included in the recommended team may exceed a quantity of piece cards held by the ally player object, or may be less than the quantity of the piece cards held by the ally player object. This is not limited in the present disclosure. The recommended virtual character is a virtual character independently selected by the ally player. For example, the virtual character includes a virtual character 1, a virtual character 2, and a virtual character 3.The ally player selects the virtual character 1 and the virtual character 2 as the recommended virtual characters for forming the recommended team. The recommended team placement is a team placement defined by the ally player, that is, a customized placement for the at least one recommended virtual character. The recommended team placement separately defines the square position of the at least one recommended virtual character. Referring to FIG. 17, the ally player may select, in a blank board area through an addition operation for the recommended team placement, a square where the recommended virtual character is to be placed, and set the square corresponding to each recommended virtual character. For example, the ally player may place a recommended virtual character 1 in a square 2, place the recommended virtual character 2 in a square 5, place a recommended virtual character 3 in a square 10, and the like, to form the recommended team placement.

The preset placement is a placement that is predetermined, and is a placement that is pre-programmed when a game program is developed. A quantity of virtual characters included in each preset placement is the same, and is generally a maximum quantity of cards that the ally player object may hold. A square occupied by the virtual character is marked in the preset placement, to indicate that the virtual character may be placed in the square position, and does not limit various virtual characters to be placed in the squares. For example, the preset placement includes the square 1, the square 2, and the square 3. The square 1 may be configured for placing the virtual character 1, or may be configured for placing the virtual character 2, or the virtual character 1 may be placed in any one of the square 1, the square 2, and the square 3. As shown in FIGS. 17, 3 preset placements are displayed on the character formation interface, each preset placement occupies 6 square positions in the board area, and the virtual character in each square position is not limited.

Operation 440: Display, in the virtual scene in response to an operation of selecting a first placement, at least one virtual character deployed based on the first placement, the first placement being any one of the at least one recommended team placement and the at least one preset placement.

The first placement may be any one of the recommended team placement and the preset placement that are displayed on the character formation interface, or may be a recommended team placement newly added through the addition operation for the recommended team placement in a current virtual battle or before participation in the virtual battle. After the ally player selects the first placement, the board area after formation is directly displayed in the virtual scene, and the board area includes at least one virtual character deployed based on the first placement. Exemplarily, the first placement is selected by the ally player from the at least one recommended team placement and the at least one preset placement based on a human-computer interaction operation.

In some embodiments, in response to the operation of selecting the first placement, the at least one virtual character deployed based on the first placement is displayed in the virtual scene based on a formation algorithm. An implementation process of the formation algorithm may be performed on a terminal device side, or may be performed on a server side. This is not limited in the present disclosure. The following explains that the formation algorithm is performed on the terminal device side.

In some embodiments, in response to an operation of selecting the first placement, the first placement displayed on the character formation interface is switched to a mirrored placement, the mirrored placement being a placement obtained by performing a mirroring operation on the first placement.

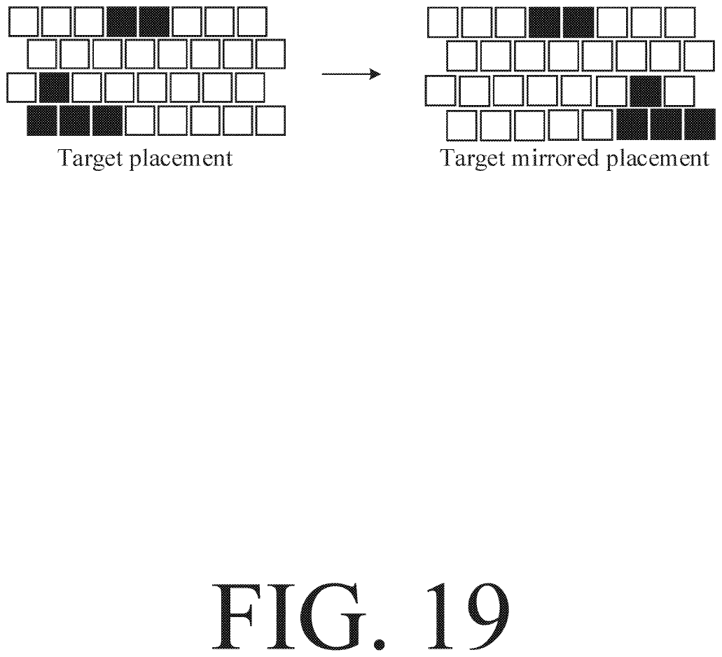

At least one position in the virtual scene occupied by the first placement and at least one position in the virtual scene occupied by the mirrored placement and the first placement are displayed in a mirror. As shown in FIG. 19, a square 1, a square 2, and a square 3 occupy a first row of the board area in the first placement. After the mirroring operation is performed on the first placement, a square 6, a square 7, and a square 8 that occupy the first row of the board area in the mirrored placement are displayed in a mirror with the squares occupied by the first placement.

In response to an operation of selecting a first placement, at least one virtual character deployed based on the first placement is displayed in the virtual scene. In addition, the first placement displayed on the character formation interface is switched to the mirrored placement. Therefore, in response to the operation of selecting the first placement, the character formation interface displays the at least one virtual character deployed based on the first placement and the mirrored placement.

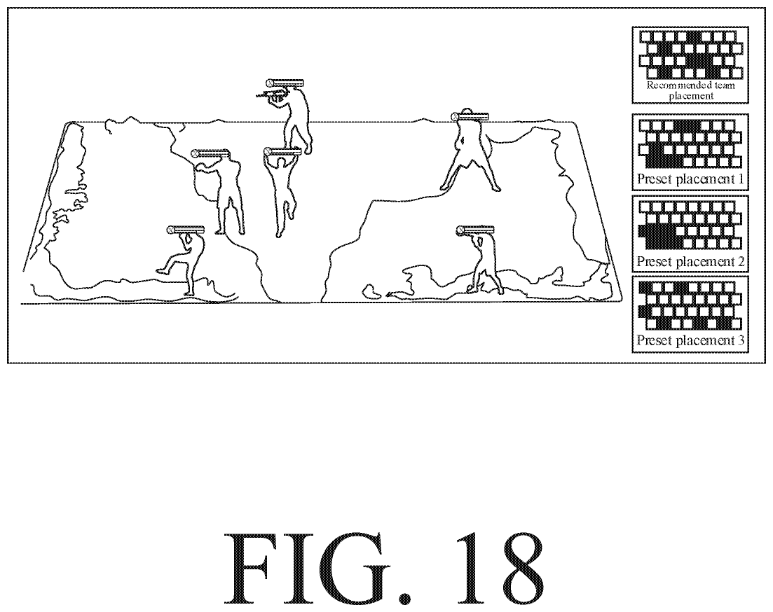

Exemplarily, FIG. 17 is a schematic diagram of a character formation interface before formation, and FIG. 18 is a schematic diagram of a character formation interface after formation based on the recommended team placement. The placement of at least one recommended virtual character in the virtual scene shown in FIG. 18 and the recommended team placement displayed in FIG. 18 are displayed in a mirror. In other words, in response to the operation of selecting the recommended team placement, at least one virtual character deployed based on the recommended team placement is displayed in the virtual scene. In addition, the recommended team placement displayed on the character formation interface is switched to the mirrored placement of the recommended team placement. Therefore, a display area of the recommended team placement in FIG. 18 displays the mirrored placement of the recommended team placement.

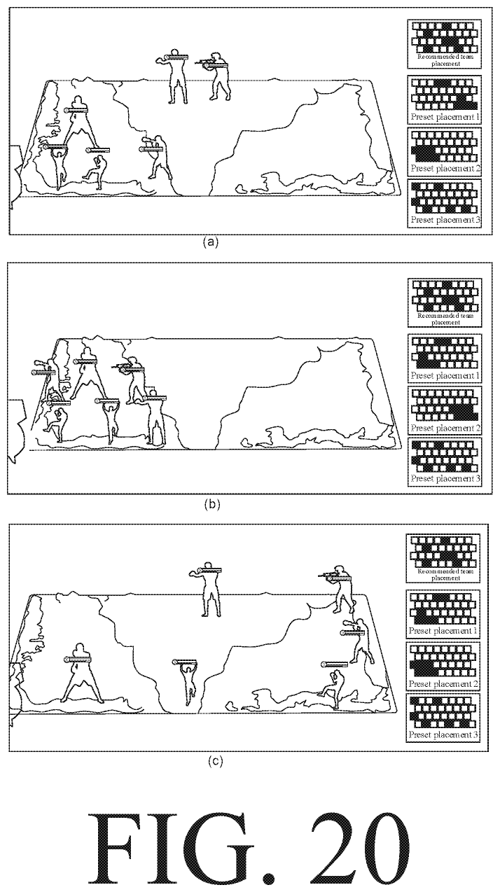

FIG. 20 is a schematic diagram of a character formation interface after formation based on a preset placement. FIG. (1) in FIG. 20 is a schematic diagram of a character formation interface after formation based on a preset placement 1. A display area of the preset placement 1 in FIG. (1) in FIG. 20 is switched to be displayed as a mirrored placement of the preset placement 1. FIG. (2) in FIG. 20 is a schematic diagram of a character formation interface after formation based on a preset placement 2. A display area of the preset placement 2 in FIG. (2) in FIG. 20 is switched to be displayed as a mirrored placement of the preset placement 2. FIG. (3) in FIG. 20 is a schematic diagram of a character formation interface after formation based on a preset placement 3. A display area of the preset placement 3 in FIG. (1) in FIG. 20 is switched to be displayed as a mirrored placement of the preset placement 3.

In some embodiments, in response to the operation of selecting the mirrored placement, at least one virtual character deployed based on the mirrored placement is displayed in the virtual scene.

The ally player selects the mirrored placement, and displays the board area after formation in the virtual scene. The board area includes at least one virtual character deployed based on the mirrored placement.

After the one-tap formation is performed, the first placement is switched to the mirrored placement, which provides a manner of quickly switching a placement for the ally player. Therefore, the player can present another placement manner through the operation of selecting the mirrored placement, and the player is facilitated to quickly change the placement of the virtual character, thereby simplifying formation operation difficulty of the player and enhancing richness of the game.

According to the technical solutions provided in the embodiments of the present disclosure, at least one recommended team placement and at least one preset placement are displayed on the character formation interface. In addition, in response to the operation of selecting the first placement, at least one virtual character deployed based on the first placement is displayed in the virtual scene. Compared with the one-tap formation function that is only specific to formation for a preset placement in the related art, the technical solutions provided in the present disclosure add a one-tap formation function that is specific to formation for the recommended team placement, so that at least one virtual character currently to be deployed can be deployed based on the recommended team placement or the preset placement by using the one-tap formation function. This improves versatility and effectiveness of the one-tap formation function, enhances placement richness provided for the virtual character, avoids a need to determine the placement of each virtual character one by one in a battle through a human-computer interaction operation, promotes human-computer interaction efficiency, simplifies difficulty of a formation operation for the player, saves time consumed by forming the virtual character in a turn-based board game, enhances gaming experience, and increases the number of battles supported by a server providing backend support for the turn-based board game per unit time.

An execution process of the formation algorithm is described in detail below, which includes at least one of operation 520 to operation 560 below.

Operation 520: Assign N to-be-deployed virtual characters to M character groups. The M character groups may be divided based on placement types, and N and M being both positive integers.

One placement type may correspond to one character group, and M character groups may correspond to M placement types. The placement types may indicate a distribution area of a square position occupied by a virtual character in the board area. A placement area corresponding to each placement type is not limited in the present disclosure.

In some embodiments, the M character groups include a front-row character group and a rear-row character group, a placement type corresponding to the front-row character group is a front-row placement type, and a placement type corresponding to the rear-row character group is a rear-row placement type. The front-row placement type may indicate that the distribution area of the square position occupied by the virtual character in the board area is in a front-row area, and the rear-row placement type may indicate that the distribution area of the square position occupied by the virtual character in the board area is in a rear-row area. Division of the front-row area and the rear-row area is not limited. The front-row area may refer to an area relative to the rear-row area, namely, an area located in front of the rear-row area, and the rear-row area may refer to an area relative to the front-row area, such as an area located at the back the front-row area. Exemplarily, the board area includes 4 rows of squares. If the front-row area is first 3 rows of squares, the rear-row area is a 4^{th} row of the squares. If the front-row area is a 1^{st} row of the squares, the rear-row area is last 3 rows of squares.

In some embodiments, the placement type may also be divided into a front-row placement type, a middle-row placement type, and a rear-row placement type. In this case, the M character groups may include a front-row character group, a middle character group, and a rear-row character group. Alternatively, the placement type may also be divided into a left-column placement type, a middle-column placement type, and a right-column placement type. The distribution area corresponding to each placement type may occupy at least one column on the board. In this case, the M character groups may include a left-column character group, a middle-column character group, and a right-column character group. Alternatively, the placement type may also be divided into an upper-left placement type, an upper-right placement type, a lower-left placement type, and a lower-right placement type. The distribution area corresponding to each placement type may occupy one corner area on the board. In this case, the M character groups may include an upper-left character group, an upper-right character group, a lower-left character group, and a lower-right character group. Exemplarily, each of the M placement types corresponds to one or more square positions on the board. As described above, a specific position of the placement type is not limited in the present disclosure, and a case in which an overlapping area exists between different placement types is not excluded.

The to-be-deployed N to-be-deployed virtual characters are assigned to the M character groups based on scores of the N to-be-deployed virtual characters with respect to the M placement types. The virtual character in each character group may be deployed in a placement area of the placement type corresponding to the character group. For example, the virtual character in the front-row character group may be deployed in the front-row area corresponding to the front-row placement type.

In some embodiments, after the N to-be-deployed virtual characters are assigned to the M character groups, one or more of the character groups may contain zero virtual characters.

In some embodiments, an i^{th} virtual character of the N to-be-deployed virtual characters is used as an example. For the i^{th} virtual character in the N to-be-deployed virtual characters, a score corresponding to the i^{th} virtual character is determined for each of M placement types, to obtain M scores, i being a positive integer less than or equal to N.

The i^{th} virtual character is assigned to a character group corresponding to a first placement type in the M placement types, the first placement type being a placement type corresponding to a maximum value in the M scores.

In some embodiments, each of the N to-be-deployed virtual characters is determined, and M scores corresponding to each virtual character are obtained for the score corresponding to each of the M placement types, thereby assigning the N to-be-arrayed virtual characters to the M character groups based on the M scores corresponding to each virtual character.

Further, operation 520 may be implemented as operation 521 to operation 525.

Operation 521: Obtain, for a j^{th} placement type in the M placement types, a character score corresponding to the i^{th} virtual character for the j^{th} placement type, the character score being configured for representing a degree of fit of the virtual character for the j^{th} placement type, and j being a positive integer less than or equal to M.

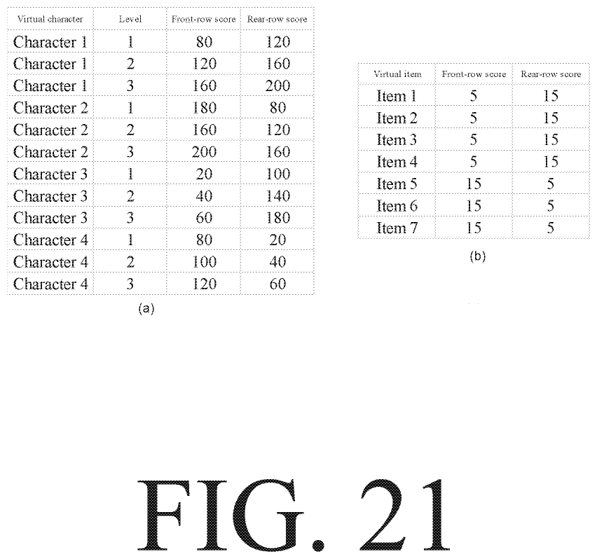

In some embodiments, each virtual character may be provided with the character scores for M placement types, and the character scores may be pre-programmed when the game program was developed, and may represent the degree of fit of the virtual character for each placement type. The character score corresponding to the i^{th} virtual character for the j^{th} placement type is configured for representing the degree of fit of the i^{th} virtual character for the j^{th} placement type, and is specifically the degree of fit of the i^{th} virtual character formation for the placement area corresponding to the j^{th} placement type. If the character score corresponding to the i^{th} virtual character for the j^{th} placement type is q maximum value in the M character scores of the i^{th} virtual character for the M placement types, the i^{th} virtual character is more suitable for the placement area corresponding to the j^{th} placement type. Different virtual characters have different character scores for the same placement type. Specifically, the character score of the virtual character for the placement type is related to a virtual character type (i.e., the foregoing piece type) and a virtual character level (i.e., the foregoing piece level). For example, as shown in FIG. 21(a), for the same virtual character, for example, a character 1, when the character thereof is at a level 1, the front-row score of the character 1 is 80; when the character thereof is at a level 2, the front-row score of the character 1 is 120; and when the character thereof is at a level 3, the front-row score of the character 1 is 160. It can be learned that a higher level of the virtual character indicates a higher character score of the virtual character for the same placement type, so that the higher-level virtual character is presented in the virtual scene in priority, to improve virtual competitive capability of the ally. For different virtual characters at the same level, a corresponding front-row score is 80 when the character 1 is at the level 1, the corresponding front score is 180 when the character 2 is at the level 1, the corresponding front score is 20 when the character 3 is at the level 1, and the corresponding front score is 80 when the character 4 is at the level 1. It can be learned that the character score of the virtual character for the placement type is related to the virtual character type. The virtual character may have the same character score or may have different character scores for different placement types. In FIG. 21(a), each virtual character may have different character scores for the front-row placement type and the rear-row placement type. If the character score of the virtual character for the front-row placement type is greater than the character score of the virtual character for the rear-row placement type, the degree of fit of the virtual character for the front-row placement type is greater than the degree of fit of the virtual character for the rear-row placement type, such as the character 2 and the character 4.

Operation 522: Obtain, if the i^{th} virtual character is equipped with L virtual items, an item score corresponding to each of the L virtual items for the j^{th} placement type, the item score being configured for representing a degree of fit of the virtual item for the j^{th} placement type, and L being a positive integer.

In some embodiments, each virtual item is equipped with item scores for M placement types, and the item scores are scores pre-programmed when the game program is developed, and are configured for representing. Each of the item scores may represent the degree of fit of the virtual item for a corresponding placement type. For example, the item score corresponding to a l^{st} virtual item for the j^{th} placement type is configured for representing the degree of fit of the l^{st} virtual item for the j^{th} placement type, and is specifically the degree of fit when the l^{st} virtual item is deployed on the virtual character in the placement area corresponding to the j^{th} placement type. If the item score corresponding to the l^{st} virtual item for the j^{th} placement type is the maximum value in the M item scores of the l^{st} virtual item for the M placement types, the l^{st} virtual item is more suitable for the placement area corresponding to the j^{th} placement type, l being a positive integer less than or equal to L. Each virtual character may be provided with at least one virtual item, and each virtual item is provided with the item score corresponding to the placement type. If the i^{th} virtual character is equipped with L virtual items, the item score corresponding to the i^{th} virtual character for the j^{th} placement type is obtained based on the item score corresponding to each of the L virtual items for the j^{th} placement type. The item score corresponding to the i^{th} virtual character for the j^{th} placement type may be a score obtained by adding the item scores corresponding to the L virtual items for the j^{th} placement type, may be a score obtained by performing weighted summation on the item scores corresponding to the L virtual items for the j^{th} placement type, or may be an average score of the item scores corresponding to the L virtual items for the j^{th} placement type. This is not limited in the present disclosure.

The item scores of different virtual items for the same placement type may be the same or may be different. As shown in FIG. (2) of FIG. 21, for different virtual items, front-row scores corresponding to an item 1 to an item 4 are all 5, and front-row scores corresponding to an item 5 to an item 7 are all 15. If the item score of the virtual item for the front-row placement type is greater than the item score of the virtual item for the rear-row placement type, the degree of fit of the virtual item for the front-row placement type is greater than the degree of fit of the virtual item for the rear-row placement type, such as the item 5, the item 6, and the item 7. In some embodiments, the virtual item has an upgradable level. In this case, the item score of the virtual item for the placement type is related to the type of the virtual item and the level of the virtual item. A higher level of the virtual item indicates a higher item score of the virtual item for the same placement type.

Operation 523: Calculate a score corresponding to the i^{th} virtual character for the j^{th} placement type based on the character score corresponding to the i^{th} virtual character for the j^{th} placement type and the item score corresponding to each of the L virtual items for the j^{th} placement type.

In some embodiments, the score corresponding to the i^{th} virtual character for the j^{th} placement type may be a score obtained by adding the character score corresponding to the i^{th} virtual character for the j^{th} placement type and the item score corresponding to each of the L virtual items for the j^{th} placement type, or may be a score obtained by performing weighted summation on the character score corresponding to the i^{th} virtual character for the j^{th} placement type and the item score corresponding to each of the L virtual items for the j^{th} placement type, or may be an average score of the character score corresponding to the i^{th} virtual character for the j^{th} placement type and the item score corresponding to each of the L virtual items for the j^{th} placement type, or the like. In some embodiments, the score corresponding to the i^{th} virtual character for the j^{th} placement type may be calculated based on the character score corresponding to the i^{th} virtual character for the j^{th} placement type and the item score corresponding to the i^{th} virtual character for the j^{th} placement type. The score corresponding to the i^{th} virtual character for the j^{th} placement type may be a score obtained by adding the character score corresponding to the i^{th} virtual character for the j^{th} placement type and the item score corresponding to the i^{th} virtual character for the j^{th} placement type, or may be a score obtained by performing weighted summation on the character score corresponding to the i^{th} virtual character for the j^{th} placement type and the item score corresponding to the i^{th} virtual character for the j^{th} placement type, or may be an average score of the character score corresponding to the i^{th} virtual character for the j^{th} placement type and the item score corresponding to the i^{th} virtual character for the j^{th} placement type, or the like.

The score corresponding to the i^{th} virtual character for the j^{th} placement type is configured for representing a comprehensive degree of fit of the virtual character for the j^{th} placement type. In some embodiments, if the i^{th} virtual character is not equipped with the virtual item, the score corresponding to the i^{th} virtual character for the j^{th} placement type is obtained based on the character score corresponding to the i^{th} virtual character for the j^{th} placement type. For example, the character score corresponding to the i^{th} virtual character for the j^{th} placement type may be directly determined as the score corresponding to the i^{th} virtual character for the j^{th} placement type.

Operation 524: Obtain the M scores based on the score corresponding to the i^{th} virtual character for each of the M placement types.

When the score corresponding to the virtual character for the placement type is calculated, with reference to the character score corresponding to the virtual character for the placement type and the item score corresponding to the virtual item for the placement type, the finally obtained score corresponding to the virtual character for the placement type comprehensively considers the placement type of the virtual character and characteristic attributes of the virtual character and the virtual item, so that the obtained score can more accurately represent the degree of fit of the virtual character for the placement type, thereby improving accuracy and rationality of subsequent grouping.

Operation 525: Assign the i^{th} virtual character to a character group corresponding to a first placement type in the M placement types, the first placement type being a placement type corresponding to a maximum value in the M scores.

After the score corresponding to the i^{th} virtual character for each of the M placement types is obtained, a maximum value in the M scores is determined, and the placement type corresponding to the maximum value in the M scores is determined as the first placement type corresponding to the i^{th} virtual character, so as to assign the i^{th} virtual character to the character group corresponding to the first placement type.

Exemplarily, if the score corresponding to the i^{th} virtual character for each of the M placement types is 80, 90, and 95, the i^{th} virtual character is assigned to the character group corresponding to the placement type corresponding to the score of 95.

In some embodiments, the M character groups include the front-row character group and the rear-row character group. The i^{th} virtual character may be assigned to the front-row character group if a score corresponding to the i^{th} virtual character for the front-row placement type is greater than a score corresponding to the i^{th} virtual character for the rear-row placement type. The front-row placement type is the first placement type corresponding to the i^{th} virtual character. For example, the i^{th} virtual character is assigned to the front-row character group corresponding to the front-row placement type.

In an embodiment, if the score corresponding to the i^{th} virtual character for the rear-row placement type is greater than the score corresponding to the i^{th} virtual character for the front-row placement type, the i^{th} virtual character is assigned to the rear-row character group. The rear-row placement type is the first placement type corresponding to the i^{th} virtual character. Therefore, the i^{th} virtual character is assigned to the rear-row character group corresponding to the rear-row placement type.

According to the foregoing operations, the score corresponding to the i^{th} virtual character for the j^{th} placement type is obtained, so as to obtain the score corresponding to the i^{th} virtual character for each of the M placement types. The comprehensive degree of fit of each virtual character for the M placement types is determined based on the score corresponding to each virtual character for the M placement types, and the virtual character is assigned to the character group corresponding to the placement type having a highest fitting degree, so that the square position of each virtual character after formation is more reasonable and better conforms to a characteristic attribute of the virtual character, and the competitive capability of the virtual character is played in the turn-based board game. By assigning the virtual character to the M placement types, the player does not need to frequently open an attribute presentation interface of the virtual character to calculate information such as the character type and the virtual item of the virtual character, thereby reducing operation pressure of the player and improving probability of winning of the ally.

Operation 540: Determine positions of virtual characters in the M character groups in the virtual scene based on the first placement and the placement types corresponding to the M character groups.

The positions of virtual characters in the M character groups in the first placement is determined based on the first placement and the placement types respectively corresponding to the M character groups.

In some embodiments, operation 540 includes at least one sub-operation of operation 541 to operation 547 (not shown in the figure).

When the first placement is the preset placement, operation 541 and operation 542 are included.

Operation 541: Obtain position priority data corresponding to the preset placement for each of the M placement types, the position priority data indicating T positions in the virtual scene that are arranged in descending order of priorities, and T being a positive integer.

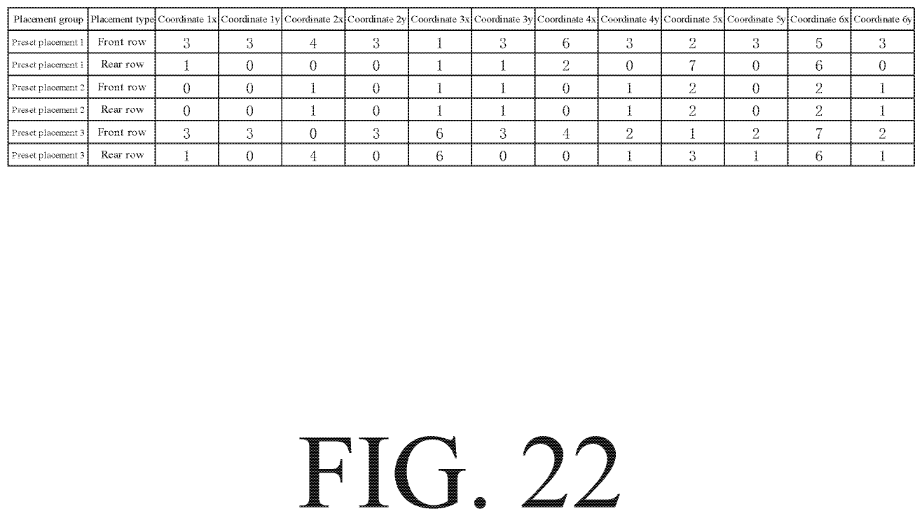

For each preset placement, a position priority table corresponding to each placement type is pre-programed when developing the game program, and the position priority data is data corresponding to the position priority table. The position priority table includes T positions in the virtual scene that are arranged in descending order of priorities. The T positions refer to T square positions on the board area in the virtual scene, and the board area includes a total of T square positions. FIG. 22 is a schematic diagram of a position priority table. Each preset placement corresponds to two placement types, each placement type corresponds to one piece of position priority data, and T is 6. For the front-row placement type of the preset placement 1, the T positions, arranged in descending order of priorities in the virtual scene, are sequentially (3, 3), (4, 3), (1, 3), (6, 3), (2, 3), and (5, 3), where (3, 3) indicates a 3^{rd} row and a 3^{rd} column in the board area.

Operation 542: Occupy, for the j^{th} placement type in the M placement types, virtual characters in a j^{th} character group in the M character groups starting from an available position with a highest priority in the T positions in descending order of scores corresponding to the virtual characters for the j^{th} placement type, and determine, in the virtual scene, positions of the virtual characters in the j^{th} character group, the placement type corresponding to the j^{th} character group being the j^{th} placement type, and j being a positive integer less than or equal to M.

Each virtual character in the j^{th} character group in the M character groups is arranged in the descending order of scores corresponding to the virtual characters for the j^{th} placement type, and is occupied starting from an available position with a highest priority in the T positions in the descending order. The available position is a position where the virtual character may be placed. In some embodiments, the ally player or the enemy player may occupy some squares in the board area by using the effect card. Therefore, the virtual character cannot be placed in the occupied square. In some embodiments, when the virtual character in another character group is deployed, some square positions are occupied, and no another virtual character may be placed in the occupied square. Therefore, the available position refers to a square position that is not occupied by the effect card and on which the another virtual character is not placed.

Exemplarily, for the front-row placement type of the preset placement 1 in the position priority table shown in FIG. 22, the virtual characters in the front-row character group are sequentially the virtual character 1, the virtual character 2, and the virtual character 3 in descending order of scores corresponding to the virtual characters for the j^{th} placement type. In this case, the virtual character 1, the virtual character 2, and the virtual character 3 sequentially occupy from the available position with the highest priority in 6 positions. (4, 3) and (1, 3) are unavailable positions. Therefore, the virtual character 1 is placed in the position corresponding to (3, 3), (4, 3) and (1, 3) are skipped, the virtual character 2 is placed in the position corresponding to (6, 3), and the virtual character 3 is placed in the position corresponding to (2, 3).

In some embodiments, quantities of the virtual characters in various character groups are obtained, and the virtual characters in various character groups are sequentially arranged based an ascending order of the quantities of the virtual characters. Exemplarily, if a 1^{st} character group includes 3 virtual characters, a 2^{nd} character group includes 4 virtual characters, and a 3^{rd} character group includes 2 virtual characters, the virtual characters in the 3^{rd} character group are first deployed, then the virtual characters in the 1^{st} character group are first deployed, and finally the virtual characters in the 2^{nd} character group are first deployed.

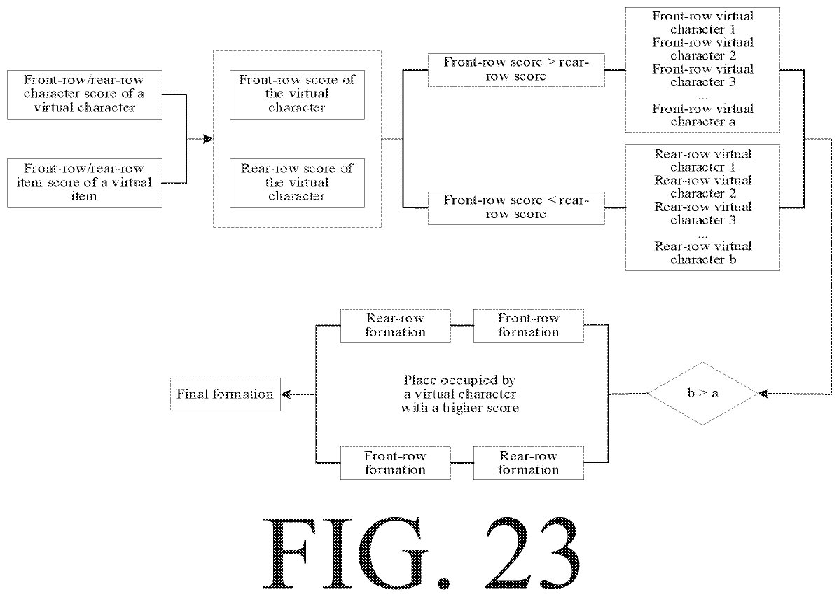

FIG. 23 is a flowchart of a formation algorithm corresponding to a preset placement. The M character groups may include a front-row character group and a rear-row character group. The front-row character group may correspond to a front-row placement type, and the rear-row character group may correspond to a rear-row placement type. First, a character score of each virtual character for the front-row placement type and a character score of each virtual character for the rear-row placement type are obtained, and an item score of the virtual item equipped to each virtual character for the front-row placement type and an item score of the virtual item equipped to each virtual character for the rear-row placement type are obtained. A score of each virtual character for the front-row placement type (i.e., the front-row score in FIG. 22) and a score of each virtual character for the rear-row placement type (i.e., the rear-row score in FIG. 22) are calculated based on the character score of each virtual character for the placement type and the item score of the virtual item equipped to each virtual character for the placement type. For each virtual character, if the front-row score is greater than the rear-row score, the virtual character is assigned to the front-row character group. If the rear-row score is greater than the front-row score, the virtual character is assigned to the rear-row character group, to obtain the front-row character group and the rear-row character group. As shown in FIG. 22, the front-row character group includes a virtual characters, and the rear-row character group includes b virtual characters. If b>a, the virtual characters in the front-row character group are first deployed, and then the virtual characters in the rear-row character group are deployed. If b<a, the virtual characters in the rear-row character group are first deployed, and then the virtual characters in the front-row character group are deployed. The formation starts occupying from the available position with the highest priority in descending order of scores corresponding to the virtual characters for the placement type, to obtain the position of each virtual character in each character group in the virtual scene, namely, a final formation result. Corresponding position priority data is respectively configured for the M placement types of the preset placement, so that each virtual character in the character group may occupy from the available position with the highest priority in descending order of scores corresponding to the virtual characters for the placement type, and each virtual character may determine the position with a high degree of fit for the virtual character in the virtual scene, so as to improve rationality of the virtual character formation, and play the competitive capability of the virtual character in the turn-based board game, thereby reducing operation pressure of the player and improving probability of winning of the ally.

When the first placement is the recommended team placement, operation 543 to operation 547 are included.

Operation 543: Assign the at least one recommended virtual character to M recommended character groups, the recommended character groups being divided based on the placement type.

The at least one recommended virtual character in the recommended team placement is obtained. Referring to the embodiment corresponding to operation 520, the at least one recommended virtual character is assigned to the M recommended character groups. In some embodiments, there may be no recommended virtual character included in the recommended character group.

Operation 544: Determine, for the j^{th} placement type in the M placement types, position ordering data corresponding to a j^{th} recommended character group based on scores corresponding to recommended virtual characters in the j^{th} recommended character group in the M recommended character groups for the j^{th} placement type, the position ordering data indicating K positions in the virtual scene that are arranged in descending order of the scores corresponding to the recommended virtual characters for the j^{th} placement type, and K being a positive integer.

If the j^{th} recommended character group includes K recommended virtual characters, the positions of the K recommended virtual characters in the virtual scene are arranged in the descending order based on the scores respectively corresponding to the recommended virtual characters in the j^{th} recommended character group for the j^{th} placement type, to obtain the K positions after the sorting.

Exemplarily, if the j^{th} recommended character group includes a recommended virtual character 1, a recommended virtual character 2, and a recommended virtual character 3, and the scores respectively corresponding to the recommended virtual characters for the j^{th} placement type are sequentially, in descending order, the recommended virtual characters being the recommended virtual character 2, the recommended virtual character 1, and the recommended virtual character 3, the 3 arranged positions included in the position ordering data corresponding to the j^{th} recommended character group are sequentially the recommended position 2 corresponding to the recommended virtual character 2, the recommended position 1 corresponding to the recommended virtual character 1, and the recommended position 3 corresponding to the recommended virtual character 3.

Operation 545: Occupy virtual characters in a j^{th} character group in the M character groups starting from an available position with a highest priority in the T positions in descending order of scores corresponding to the virtual characters for the j^{th} placement type, and determine, in the virtual scene, positions of the virtual characters in the j^{th} character group, the placement type corresponding to the j^{th} character group being the j^{th} placement type, and j being a positive integer less than or equal to M.

Exemplarily, if the quantity of the available positions in the K positions is greater than or equal to the quantity of the virtual characters in the j^{th} character group, the position for each virtual character in the j^{th} character group is occupied from the available position with the highest score in the K positions in descending order of scores corresponding to the virtual characters for the j^{th} placement type, and the positions of virtual characters in the j^{th} character group in the virtual scene are determined.

Exemplarily, the quantity of the available positions in the K positions is 3, and the available positions are sequentially arranged as the recommended position 2, the recommended position 1, and the recommended position 3 in descending order of scores corresponding to the recommended virtual characters for the j^{th} placement type. The quantity of the virtual characters in the j^{th} character group is 2, and the virtual characters are sequentially arranged as the virtual character 1 and the virtual character 2 in descending order of scores corresponding to the virtual characters for the j^{th} placement type. In this case, the virtual character 1 is placed in the recommended position 2, and the virtual character 2 is placed in the recommended position 1. Each position in the recommended team placement is arranged based on the scores, so that each virtual character in the character group may occupy from the available position with the highest score in the recommended character group in descending order of scores corresponding to the virtual characters for the placement type, and each virtual character may determine the position with the high degree of fit for the virtual character in the virtual scene, thereby improving rationality of the virtual character formation, reducing operation pressure of the player, and improving probability of winning of the ally.

Exemplarily, operation 543 to operation 545 may be combined with operation 520 above, operation 560 below, and operation 420 in FIG. 16 into a new embodiment to be independently implemented. This is not limited in the present disclosure.

Operation 546: Obtain position priority data corresponding to the first placement for each of the M placement types if a quantity of available positions in the K positions is less than the quantity of virtual characters in the j^{th} character group, the position priority data indicating T positions in the virtual scene that are arranged in descending order of priorities, and T being a positive integer.

In this operation, the first placement is any one of the at least one preset placement. Exemplarily, the quantity of the available positions in the K positions is 3, and the available positions are sequentially arranged as the recommended position 2, the recommended position 1, and the recommended position 3 in descending order of scores corresponding to the recommended virtual characters for the j^{th} placement type. The quantity of the virtual characters in the j^{th} character group is 4, and the virtual characters are sequentially arranged as the virtual character 1, the virtual character 2, the virtual character 3,and the virtual character 4 in descending order of scores corresponding to the virtual characters for the j^{th} placement type. Referring to the embodiments of operation 543 to operation 545, the virtual character 1, the virtual character 2, and the virtual character 3 are arranged, and the positions of the virtual character 1, the virtual character 2, and the virtual character 3 in the virtual scene are determined. In other words, the virtual character 1corresponds to the recommended position 2, the virtual character 2 corresponds to the recommended position 1, and the virtual character 3 corresponds to the recommended position 3. For determining the position of the virtual character 4 in the virtual scene, reference may be made to the embodiment of operation 541 to operation 542. Details are not described herein again. The first placement is a placement in the preset placements. A selection rule for the first placement may be a preset placement defined by a programmer when the game is developed, may be a preset placement independently selected by the player, or may be a frequently-used preset placement determined by a game program based on a use probability of the preset placement in big data. This is not limited in the present disclosure.

Operation 547: Assign, starting from an available position having a highest priority in the T positions corresponding to the position priority data, positions of remaining virtual characters in the j^{th} character group in descending order of scores corresponding to the remaining virtual characters for the j^{th} placement type, and determine positions of the remaining virtual characters in the virtual scene.

For the remaining virtual characters in the j^{th} character group, the position of each remaining virtual character in the virtual scene may be determined based on the embodiments of operation 541 to operation 542.

The remaining virtual characters may be deployed based on the formation algorithm corresponding to the preset placement, so that formation difficulty of the system is reduced and rationality of virtual character formation is improved while ensuring the degree of fit between the virtual characters and the positions in the virtual scene.

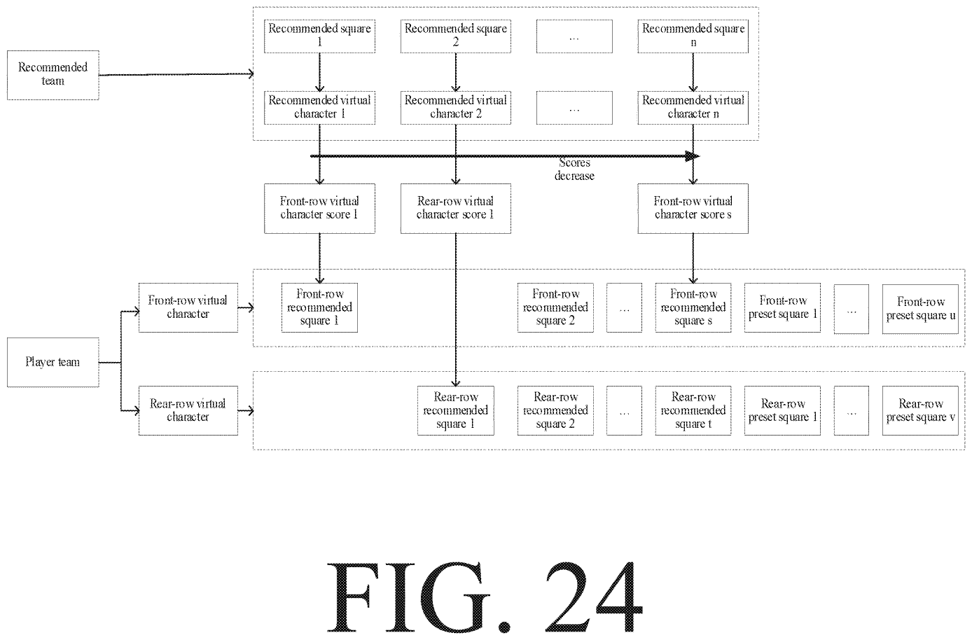

FIG. 24 is a flowchart of a formation algorithm corresponding to a recommended team placement. M character groups include a front-row character group and a rear-row character group. The front-row character group corresponds to a front-row placement type, and the rear-row character group corresponds to a rear-row placement type. First, for at least one recommended virtual character in the recommended team placement, the score corresponding to each recommended virtual character for the front-row placement type and the score corresponding to each recommended virtual character for the rear-row placement type are calculated, and the at least one recommended virtual character is respectively assigned to the front recommended character group and the rear recommended character group based on the score of each recommended virtual character for the placement type. Simultaneously, for at least one virtual character in the player team, the score corresponding to each virtual character for the front-row placement type and the score corresponding to each virtual character for the rear-row placement type are calculated, and the at least one virtual character is assigned to the front-row character group and the rear-row character group based on the score of each virtual character for the placement type. The front-row recommended character group includes s recommended virtual characters, the rear-row recommended character group includes t recommended virtual characters, and each recommended virtual character corresponds to one recommended square. Based on a sequence in the front-row recommended character group and the sequence in the front-row character group, each virtual character in the front recommended character group is placed on a recommended square corresponding to each recommended virtual character in the front recommended character group. Based on the sequence in the rear-row recommended character group and the sequence in the rear-row character group, each virtual character in the rear-row character group is placed on the recommended square corresponding to each recommended virtual character in the rear recommended character group. The remaining virtual characters in the character group are deployed based on the formation algorithm corresponding to the preset placement, to determine the square position of each remaining virtual character in the virtual scene.

Operation 560: Display, in the virtual scene, the one or more virtual characters at the one or more positions.

After the position of the virtual character in the M character groups in the virtual scene is determined, each virtual character in the M character groups is placed in the corresponding square position in the virtual scene, to obtain at least one virtual character based on the first placement, and the character formation interface is displayed as a board interface after formation. The N to-be-deployed virtual characters are deployed by using the formation algorithm corresponding to the first placement, so that each virtual character can determine the position most suitable for the first placement in the virtual scene, thereby improving rationality of virtual character formation, satisfying a gaming experience requirement of the player, reducing operation pressure and operation difficulty of the player, reducing a time consumed for arranging the virtual characters in the turn-based board game, improving gaming experience, and increasing a quantity of battles supported by the server providing backend support for the turn-based board game per unit time.

An apparatus embodiment of the present disclosure is described below, which may be configured for performing the method embodiment of the present disclosure. For details not disclosed in the apparatus embodiment of the present disclosure, reference is made to the method embodiments of the present disclosure.

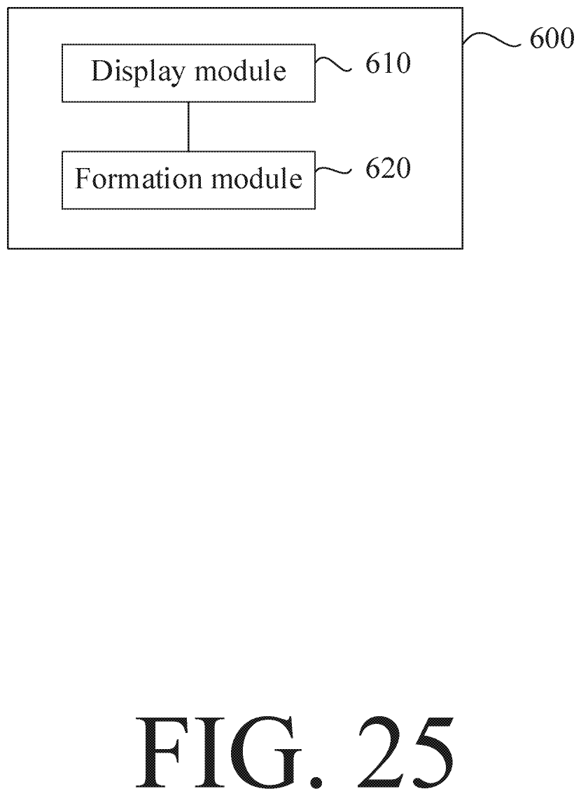

FIG. 25 is a block diagram of a character formation apparatus in a virtual scene according to an embodiment of the present disclosure. The apparatus has a function for implementing the foregoing character formation method in a virtual scene. The function may be implemented by hardware, or may alternatively be implemented by hardware executing corresponding software. The apparatus may be the terminal device described above, or may be arranged in the terminal device. As shown in FIG. 25, an apparatus 600 may include: a display module 610, configured to perform operation 420 in the embodiment shown in FIG. 16; and a formation module 620, configured to perform operation 440 in the embodiment shown in FIG. 16.

In some embodiments, the formation module 620 includes: a character assignment unit, configured to assign N to-be-deployed virtual characters to M character groups, the character groups being divided based on placement types, and N and M being both positive integers; a position determining unit, configured to determine positions of virtual characters in the M character groups in the virtual scene based on the first placement and the placement types corresponding to the M character groups; and a formation unit, configured to display, in the virtual scene based on the positions of the virtual characters in the M character groups in the virtual scene, the at least one virtual character deployed based on the first placement.

In some embodiments, the character assignment unit is configured to: determine, for an i^{th} virtual character in the N virtual characters, a score corresponding to the i^{th} virtual character for each of M placement types, to obtain M scores, i being a positive integer less than or equal to N; and assign the i^{th} virtual character to a character group corresponding to a first placement type in the M placement types, the first placement type being a placement type corresponding to a maximum value in the M scores.

In some embodiments, the character assignment unit is configured to: obtain, for a j^{th} placement type in the M placement types, a character score corresponding to the i^{th} virtual character for the j^{th} placement type, the character score being configured for representing a degree of fit of the virtual character for the j^{th} placement type, and j being a positive integer less than or equal to M; obtain, if the i^{th} virtual character is equipped with L virtual items, an item score corresponding to each of the L virtual items for the j^{th} placement type, the item score being configured for representing a degree of fit of the virtual item for the j^{th} placement type, and L being a positive integer; calculate a score corresponding to the i^{th} virtual character for the j^{th} placement type based on the character score corresponding to the i^{th} virtual character for the j^{th} placement type and the item score corresponding to each of the L virtual items for the j^{th} placement type; and obtain the M scores based on the score corresponding to the i^{th} virtual character for each of the M placement types.

In some embodiments, the position determining unit is configured to: obtain position priority data corresponding to the preset placement for each of the M placement types when the first placement is the preset placement, the position priority data indicating T positions in the virtual scene that are arranged in descending order of priorities, and T being a positive integer; and occupy, for the j^{th} placement type in the M placement types, virtual characters in a j^{th} character group in the M character groups starting from an available position with a highest priority in the T positions in descending order of scores corresponding to the virtual characters for the j^{th} placement type, and determine, in the virtual scene, positions of the virtual characters in the j^{th} character group, the placement type corresponding to the j^{th} character group being the j^{th} placement type, and j being a positive integer less than or equal to M.

In some embodiments, the position determining unit is configured to: assign the at least one recommended virtual character to M recommended character groups when the first placement is the recommended team placement, the recommended character groups being divided based on the placement type; determine, for the j^{th} placement type in the M placement types, position ordering data corresponding to a j^{th} recommended character group based on scores corresponding to recommended virtual characters in the j^{th} recommended character group in the M recommended character groups for the j^{th} placement type, the position ordering data indicating K positions in the virtual scene that are arranged in descending order of the scores corresponding to the recommended virtual characters for the j^{th} placement type, and K being a positive integer; and occupy, starting from an available position with a highest score in the K positions, virtual characters in a j^{th} character group in the M character groups in descending order of scores corresponding to the virtual characters for the j^{th} placement type, and determine, in the virtual scene, positions of the virtual characters in the j^{th} character group, the placement type corresponding to the j^{th} character group being the j^{th} placement type, and j being a positive integer less than or equal to M.

In some embodiments, the first placement is any one of the at least one preset placement, and the position determining unit is configured to: obtain position priority data corresponding to the first placement for each of the M placement types if a quantity of available positions in the K positions is less than the quantity of virtual characters in the j^{th} character group, the position priority data indicating T positions in the virtual scene that are arranged in descending order of priorities, and T being a positive integer; and occupy, starting from an available position having a highest priority in the T positions corresponding to the position priority data, positions of remaining virtual characters in the j^{th} character group in descending order of scores corresponding to the remaining virtual characters for the j^{th} placement type, and determine positions of the remaining virtual characters in the virtual scene.

In some embodiments, the M character groups include a front-row character group and a rear-row character group, a placement type corresponding to the front-row character group is a front-row placement type, and a placement type corresponding to the rear-row character group is a rear-row placement type; and the character assignment unit is configured to: assign the i^{th} to-be-deployed virtual character to the rear-row character group if the score corresponding to the i^{th} to-be-deployed virtual character for the rear-row placement type is greater than the score corresponding to the i^{th} to-be-deployed virtual character for the front-row placement type; and assign the i^{th} to-be-deployed virtual character to the front-row character group if a score corresponding to the i^{th} to-be-deployed virtual character for the front-row placement type is greater than a score corresponding to the i^{th} to-be-deployed virtual character for the rear-row placement type.

In some embodiments, the apparatus 600 further includes a mirror display module. The mirror display module is configured to: switch, in response to an operation of selecting the first placement, the first placement displayed on the character formation interface to a mirrored placement, the mirrored placement being a placement obtained by performing a mirroring operation on the first placement.

In some embodiments, the mirror display module is configured to display, in response to an operation of selecting the mirrored placement, at least one virtual character deployed based on the mirrored placement in the virtual scene.

When the apparatus provided in the foregoing embodiments implements functions of the apparatus, division of the foregoing various functional modules is merely used as an example for description. In an actual application, the function distribution may be finished by different functional modules according to actual requirements, that is, a content structure of a device is divided into different functional modules, so as to complete all or some of the functions described above. In addition, the apparatus provided in the foregoing embodiments and the method embodiments belong to the same concept. For details of a specific implementation process, reference may be made to the method embodiments. Details are not described herein again.

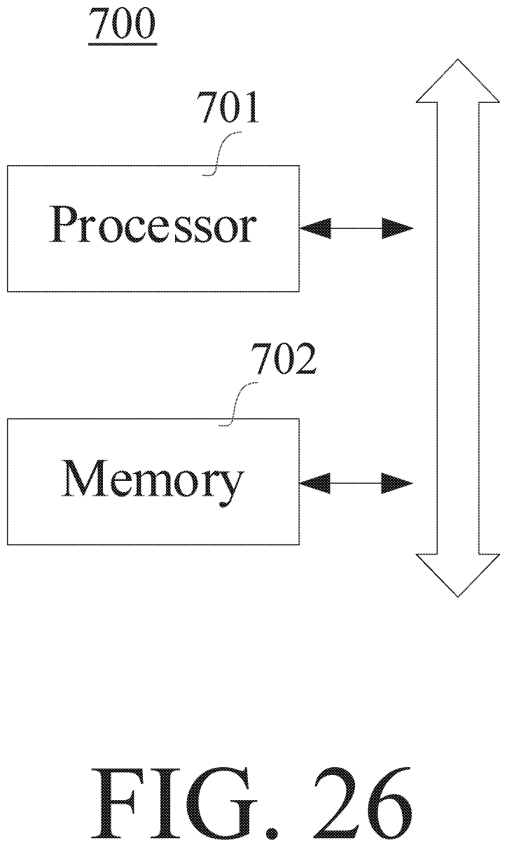

FIG. 26 is a structural block diagram of a computer device 700 according to an embodiment of the present disclosure. The computer device 700 may be any electronic device having data calculating, processing, and storage functions. The computer device 700 may be configured to implement the character formation method in a virtual scene provided in the foregoing embodiments.

The computer device 700 may include a processor 701 and a memory 702.

The processor 701 may include one or more processing cores, for example, a 4-core processor and an 8-core processor. The processor 701 may be implemented by using at least one of the following hardware forms: a digital signal processor (DSP), a field programmable gate array (FPGA), and a programmable logic array (PLA). The processor 701 may alternatively include a main processor and a coprocessor. The main processor is a processor configured to process data in an awake state, and is also referred to as a central processing unit (CPU). The coprocessor is a low power consumption processor configured to process the data in a standby state. In some embodiments, the processor 701 may be integrated with a graphics processing unit (GPU). The GPU is configured to render and draw content that needs to be displayed on a display screen. In some embodiments, the processor 701 may further include an artificial intelligence (AI) processor. The AI processor is configured to process computing operations related to machine learning.

The memory 702 may include one or more computer-readable storage media. The computer-readable storage medium may be non-transient. The memory 702 may further include a high-speed random access memory (RAM) and a nonvolatile memory, for example, one or more disk storage devices or flash storage devices. In some embodiments, the non-transitory computer-readable storage medium in the memory 702 is configured to store a computer program, and the computer program is configured to be executed by one or more processors, to implement the foregoing character formation method in a virtual scene.

A person skilled in the art may understand that the structure shown in FIG. 26 does not constitute a limitation on the computer device 700, and the computer device may include more or fewer assemblies than those shown in the figure, a combination of some assemblies, or different assembly arrangements.

In an exemplary embodiment, a computer-readable storage medium is further provided. The computer-readable storage medium has a computer program stored thereon. The computer program, when executed by a processor of the computer device, implements the foregoing character formation method in a virtual scene. In some embodiments, the foregoing computer-readable storage medium may be a read-only memory (ROM), a RAM, a compact disc read-only memory (CD-ROM), a magnetic tape, a floppy disk, an optical data storage device, and the like.

In an exemplary embodiment, a computer program product is further provided. The computer program product includes a computer program, the computer program being stored in a computer-readable storage medium. A processor of a computer device reads the computer program from the computer-readable storage medium, and the processor executes the computer program, so that the computer device performs the foregoing character formation method in a virtual scene.

In the present disclosure, a prompt interface and a pop-up window may be displayed or voice prompt information may be outputted before and during collection of relevant data of a user. The prompt interface, the pop-up window, or the voice prompt information is configured for prompting the user that relevant data of the user is currently being collected. Therefore, in the present disclosure, relevant operations of obtaining user-related data are performed only after a confirmation operation performed by the user on the prompt interface or the pop-up window is obtained. Otherwise (i.e., when no confirmation operation performed by the user on the prompt interface or the pop-up window is obtained), the relevant operations of obtaining user-related data are ended, i.e., the user-related data is not obtained. In other words, all user data collected in the present disclosure is processed in strict accordance with a requirement of relevant national laws and regulations, and an informed consent or an individual consent of a personal information subject is collected with consent and authorization of the user. Within the scope of laws and regulations and the authorization of the personal information subject, the subsequent use and processing of data and the collection, use and processing of relevant user data shall comply with the relevant laws, regulations, and standards of relevant countries and regions.

A term “a plurality of” mentioned herein means two or more than two. A term “and/or” means an association relationship for describing associated objects and represents that three relationships may exist. For example, A and/or B may represent the following three cases: only A exists, both A and B exist, and only B exists. A character “/” generally indicates an “or” relationship between associated objects. In addition, the operation numbers described in this specification merely exemplarily show a possible execution sequence of the operations. In some other embodiments, the foregoing operations may not be performed based on the number sequence. For example, two operations with different numbers may be simultaneously performed, or two operations with different numbers may be performed based on a sequence contrary to the sequence shown in the figure. This is not limited in the embodiments of the present disclosure.

The foregoing descriptions are merely exemplary embodiments of the present disclosure, but are not intended to limit the present disclosure. Any modification, equivalent replacement, or improvement made within the spirit and principle of this application shall fall within the protection scope of the present disclosure.

What is claimed is:

1. A method of character formation in a virtual scene, the method being performed by a terminal, and the method comprising:
displaying a character formation interface comprising the virtual scene, at least one recommended team placement, and at least one preset placement, the at least one recommended team placement being a placement of a recommended team comprising at least one recommended virtual character, the at least one preset placement being a placement that is predetermined, and each of the at least one recommended team placement and the at least one preset placement occupies at least one of a plurality of positions of the virtual scene; and
when an operation of selecting a first placement is selected, displaying, in the virtual scene, one or more virtual characters at one or more positions of the plurality of positions based on the first placement, the first placement being one of the at least one recommended team placement or one of the at least one preset placement.

2. The method according to claim 1, wherein the displaying, in the virtual scene, the one or more virtual characters at the one or more positions of the plurality of positions comprises:
assigning the one or more virtual characters to M character groups, the M character groups being divided based on placement types, and M being a positive integer;
determining the one or more positions of the one or more virtual characters in the M character groups in the virtual scene based on the first placement and the placement types corresponding to the M character groups; and
displaying, in the virtual scene, the one or more virtual characters at the one or more positions.

3. The method according to claim 2, wherein the assigning the one or more virtual characters to M character groups comprises:
determining, for an i^{th} virtual character of the one or more virtual characters, a score corresponding to the i^{th} virtual character for each of M placement types, i being a positive integer less than or equal to N;
based on the determining the score corresponding to the i^{th} virtual character for each of M placement types, obtaining M scores; and
assigning the i^{th} virtual character to a character group among the M character groups corresponding to a first placement type of the M placement types, the first placement type corresponding to a maximum value in the M scores.

4. The method according to claim 3, wherein the determining the score corresponding to the i^{th} virtual character for each of M placement types comprises:
obtaining, for a j^{th} placement type of the M placement types, a character score corresponding to the i^{th} virtual character, the character score representing a degree of fit of the i^{th} virtual character for the j^{th} placement type, and j being a positive integer less than or equal to M;
based on the i^{th} virtual character being equipped with L virtual items, obtain an item score corresponding to each of the L virtual items for the j^{th} placement type, the item score representing a degree of fit of the virtual item for the j^{th} placement type, and L being a positive integer;
calculating the score corresponding to the i^{th} virtual character for the j^{th} placement type based on the character score and the item score; and
obtaining the M scores based on the score corresponding to the i^{th} virtual character for each of the M placement types.

5. The method according to claim 3, wherein the determining the positions of to-be-deployed virtual characters in the M character groups in the virtual scene comprises:
obtaining position priority data corresponding to the at least one preset placement for each of the M placement types when the first placement is the at least one preset placement, the position priority data indicating T positions in the virtual scene that are arranged in descending order of priority, and T being a positive integer;
assigning, for the j^{th} placement type of the M placement types, virtual characters in a j^{th} character group of the M character groups among available positions among the T positions in descending order of scores corresponding to the virtual characters for the j^{th} placement type; and
determining, in the virtual scene, positions of the virtual characters in the j^{th} character group, the placement type corresponding to the j^{th} character group being the j^{th} placement type, and j being a positive integer less than or equal to M.

6. The method according to claim 3, wherein the determining the one or more positions of virtual characters in the M character groups in the virtual scene comprises:
assigning at least one recommended virtual character to M recommended character groups when the first placement is the recommended team placement, the recommended character groups being divided based on the placement types;
determining, for the j^{th} placement type of the M placement types, position ordering data corresponding to a j^{th} recommended character group based on scores corresponding to recommended virtual characters in the j^{th} recommended character group of the M recommended character groups for the j^{th} placement type, the position ordering data indicating K positions in the virtual scene that are arranged in descending order of the scores corresponding to the recommended virtual characters for the j^{th} placement type, and K being a positive integer;
assigning, for the j^{th} placement type, virtual characters in a j^{th} character group in the M character groups to available positions among K positions in descending order of scores corresponding to the virtual characters for the j^{th} placement type; and
determining, in the virtual scene, positions of the virtual characters in the j^{th} character group, the placement type corresponding to the j^{th} character group being the j^{th} placement type, and j being a positive integer less than or equal to M.

7. The method according to claim 6, wherein the first placement is one of the at least one preset placement, and the method further comprises:
obtaining position priority data corresponding to the first placement for each of the M placement types when a quantity of available positions of the K positions is less than a quantity of virtual characters in the j^{th} character group, the position priority data indicating T positions in the virtual scene that are arranged in descending order of priorities, and T being a positive integer; and
assigning, starting from an available position having a highest priority in the T positions corresponding to the position priority data, remaining virtual characters in the j^{th} character group to positions among the T positions in descending order of scores corresponding to the remaining virtual characters for the j^{th} placement type; and
determining the positions of the remaining virtual characters in the virtual scene.

8. The method according to claim 3, wherein the M character groups comprise a front-row character group and a rear-row character group, a placement type corresponding to the front-row character group is a front-row placement type, and a placement type corresponding to the rear-row character group is a rear-row placement type, and
wherein the assigning the i^{th} virtual character to the character group corresponding to a first placement type comprises:
assigning the i^{th} virtual character to the front-row character group when the score corresponding to the i^{th} virtual character for the front-row placement type is greater than the score corresponding to the i^{th} virtual character for the rear-row placement type; and
assigning the i^{th} virtual character to the rear-row character group when the score corresponding to the i^{th} virtual character for the rear-row placement type is greater than the score corresponding to the i^{th} virtual character for the front-row placement type.

9. The method according to claim 1, further comprising:
when the operation of selecting the first placement is selected, switching the first placement displayed on the character formation interface to a mirrored placement, the mirrored placement being obtained by performing a mirroring operation on the first placement.

10. The method according to claim 9, further comprising:
when an operation of selecting the mirrored placement is selected, displaying the one or more virtual characters based on the mirrored placement in the virtual scene.

11. A character formation apparatus for a virtual scene, the character formation apparatus comprising:
at least one memory configured to store program code; and
at least one processor configured to read the program code and operate as instructed by the program code, the program code including:
display code configured to cause the at least one processor to display a character formation interface comprising the virtual scene, at least one recommended team placement, and at least one preset placement, the at least one recommended team placement being a placement of a recommended team comprising at least one recommended virtual character, the at least one preset placement being a placement that is predetermined, and each of the at least one recommended team placement and the at least one preset placement occupies at least one of a plurality of positions of the virtual scene; and
formation code configured to, when an operation of selecting a first placement is selected, display, in the virtual scene, one or more virtual characters at one or more positions of the plurality of positions based on the first placement, the first placement being one of the at least one recommended team placement or one of the at least one preset placement.

12. The character formation apparatus of claim 11, wherein the formation code is further configured to cause the at least one processor to:
assign the one or more virtual characters to M character groups, the M character groups being divided based on placement types, and M being a positive integer;
determine the one or more positions of the one or more virtual characters in the M character groups in the virtual scene based on the first placement and the placement types corresponding to the M character groups; and
display, in the virtual scene, the one or more virtual characters at the one or more positions.

13. The character formation apparatus of claim 12, wherein the formation code is further configured to cause the at least one processor to:
determine, for an i^{th} virtual character of the one or more virtual characters, a score corresponding to the i^{th} virtual character for each of M placement types, i being a positive integer less than or equal to N;
based on the score corresponding to the i^{th} virtual character for each of M placement types being determined, obtain M scores; and
assign the i^{th} virtual character to a character group among the M character groups corresponding to a first placement type of the M placement types, the first placement type corresponding to a maximum value in the M scores.

14. The character formation apparatus of claim 13, wherein the formation code is further configured to cause the at least one processor to:
obtain, for a j^{th} placement type of the M placement types, a character score corresponding to the i^{th} virtual character, the character score representing a degree of fit of the i^{th} virtual character for the j^{th} placement type, and j being a positive integer less than or equal to M;
based on the i^{th} virtual character being equipped with L virtual items, obtain an item score corresponding to each of the L virtual items for the j^{th} placement type, the item score representing a degree of fit of the virtual item for the j^{th} placement type, and L being a positive integer;
calculate the score corresponding to the i^{th} virtual character for the j^{th} placement type based on the character score and the item score; and
obtain the M scores based on the score corresponding to the i^{th} to-be-deployed virtual character for each of the M placement types.

15. The character formation apparatus of claim 13, wherein the formation code is further configured to cause the at least one processor to:
obtain position priority data corresponding to the at least one preset placement for each of the M placement types when the first placement is the at least one preset placement, the position priority data indicating T positions in the virtual scene that are arranged in descending order of priority, and T being a positive integer;
assign, for the j^{th} placement type of the M placement types, virtual characters in a j^{th} character group of the M character groups among available positions among the T positions in descending order of scores corresponding to the virtual characters for the j^{th} placement type; and
determine, in the virtual scene, positions of the virtual characters in the j^{th} character group, the placement type corresponding to the j^{th} character group being the j^{th} placement type, and j being a positive integer less than or equal to M.

16. The character formation apparatus of claim 13, wherein the formation code is further configured to cause the at least one processor to:
assign at least one recommended virtual character to M recommended character groups when the first placement is the recommended team placement, the recommended character groups being divided based on the placement types;
determine, for the j^{th} placement type of the M placement types, position ordering data corresponding to a j^{th} recommended character group based on scores corresponding to recommended virtual characters in the j^{th} recommended character group of the M recommended character groups for the j^{th} placement type, the position ordering data indicating K positions in the virtual scene that are arranged in descending order of the scores corresponding to the recommended virtual characters for the j^{th} placement type, and K being a positive integer;
assign for the j^{th} placement type, virtual characters in a j^{th} character group in the M character groups to available positions among K positions in descending order of scores corresponding to the virtual characters for the j^{th} placement type; and
determine, in the virtual scene, positions of the virtual characters in the j^{th} character group, the placement type corresponding to the j^{th} character group being the j^{th} placement type, and j being a positive integer less than or equal to M.

17. The character formation apparatus of claim 13, wherein the first placement is one of the at least one preset placement, and
wherein the formation code is further configured to cause the at least one processor to:
obtain position priority data corresponding to the first placement for each of the M placement types when a quantity of available positions of the K positions is less than a quantity of virtual characters in the j^{th} character group, the position priority data indicating T positions in the virtual scene that are arranged in descending order of priorities, and T being a positive integer; and
assign, starting from an available position having a highest priority in the T positions corresponding to the position priority data, remaining virtual characters in the j^{th} character group to positions among the T positions in descending order of scores corresponding to the remaining virtual characters for the j^{th} placement type; and
determine the positions of the remaining virtual characters in the virtual scene.

18. The character formation apparatus of claim 13, wherein the M character groups comprise a front-row character group and a rear-row character group, a placement type corresponding to the front-row character group is a front-row placement type, and a placement type corresponding to the rear-row character group is a rear-row placement type, and
wherein the formation code is further configured to cause the at least one processor to:
assign the i^{th} virtual character to the front-row character group when the score corresponding to the i^{th} virtual character for the front-row placement type is greater than the score corresponding to the i^{th} virtual character for the rear-row placement type; and
assign the i^{th} virtual character to the rear-row character group when the score corresponding to the i^{th} virtual character for the rear-row placement type is greater than the score corresponding to the i^{th} virtual character for the front-row placement type.

19. The character formation apparatus of claim 11, further comprising:
switching code configured to cause the at least one processor to, when the operation of selecting the first placement is selected, switch the first placement displayed on the character formation interface to a mirrored placement, the mirrored placement being obtained by performing a mirroring operation on the first placement.

20. A non-transitory computer readable medium storing instructions that, when executed by one or more processors, cause the one or more processors to:
display a character formation interface comprising a virtual scene, at least one recommended team placement, and at least one preset placement, the at least one recommended team placement being a placement of a recommended team comprising at least one recommended virtual character, the at least one preset placement being a placement that is predetermined, and each of the at least one recommended team placement and the at least one preset placement occupies at least one of a plurality of positions of the virtual scene; and
when an operation of selecting a first placement is selected, display, in the virtual scene, one or more virtual characters at one or more positions of the plurality of positions based on the first placement, the first placement being one of the at least one recommended team placement or one of the at least one preset placement.
